(19) United States
(12) Patent Application Publication
(10) Pub. No.: US 2017/0278417 A1
(43) Pub. Date: Sep. 28, 2017

(54) EVALUATING TEST TAKING

(71) Applicant: Eyessessment Technologies Ltd., Ramat-HaSharon (IL)

(72) Inventors: Shmuel UR, Shorashim (IL); Shay BUSHINSKY, Ganei-Tikva (IL); Tal Miron, Ganei-Tikva (IL); Dan GENDELMAN, Ramat-HaSharon (IL)

(73) Assignee: Eyessessment Technologies Ltd., Ramat-HaSharon (IL)

(21) Appl. No.: 15/506,760

(22) PCT Filed: Aug. 27, 2015
(86) PCT No.: PCT/IL15/50868

§ 371 Date: Feb. 27, 2017

Related U.S. Application Data
(60) Provisional application No. 62/042,271, filed on Aug. 27, 2014.

(51) Int. Cl. G09B 7/06; G06K 9/00; G09B 5/06

(52) U.S. Cl. CPC G09B 7/06; G09B 5/065; G06K 9/00604; G06K 9/00617

(57) ABSTRACT

Methods of and systems for relating patterns of eye movement to aspects of test performance are described. Measurable eye movement patterns in relation to a test potentially reflect problem solving strategies used by a test taker. In some embodiments, movement patterns are evaluated to indicate a level of engagement with the material. Potentially, this provides a basis for flagging test cheating, and/or identification of weaknesses in test taking skills. In some embodiments, non-eye movement behaviors are monitored. In some embodiments, monitored behaviors are used as an auxiliary to the test itself—for example, to augment scoring, and/or to reduce dependence of test results on test skills as such.

### FIELD AND BACKGROUND OF THE INVENTION

The present invention, in some embodiments thereof, relates to the field of tracking behavior to determine attention, and more particularly, to tracking attentional behavior for monitoring of test performance.

A number of methods are known for measuring the position of the eye and/or head such that a direction of gaze can be inferred within a few minutes of arc. Because of the close association between gaze direction and attention for many tasks, some uses of gaze tracking are based on the proposition that the region intersecting the direction of gaze is being attended to. Eye tracking is used, for example, to test usability features of web pages, attention-capturing properties of advertising material, and/or to examine driver attentiveness.

Movement of a pointer or indicator, such as a mouse cursor, is also potentially associated with the focus of attention for some tasks.

### SUMMARY OF THE INVENTION

According to an aspect of some embodiments, there is provided a method of detecting cheating in the provision of an answer an exam item, comprising: logging locations within the exam item indicated by gaze directions of an exam subject toward a presentation of the exam item; classifying automatically the logged locations using at least one location profile adapted to classify logged locations to a classification of cheating; and indicating potential cheating, based on the classifying.

According to some embodiments, the indicating of potential cheating comprises an indicated level of confidence that cheating is occurring.

According to some embodiments, the level of confidence is adjusted according to the result of one or more previous classifyings.

According to some embodiments, the provided answer is correct.

According to some embodiments, the logging of gaze direction-indicated locations within the exam item comprises automatic tracking of eye movement of the exam subject by a gaze tracking apparatus.

According to some embodiments, the method comprises logging exam item locations indicated by manipulation of an input device configured to indicate locations of the presentation.

According to some embodiments, the logging comprises recording when the exam item locations are indicated.

According to some embodiments, the at least one location profile comprises at least one event description, and the classifying comprises mapping the indicated exam item locations to the at least one event description.

According to some embodiments, the at least one event description comprises a range of one or more of the following parameters to which the indicated exam item locations are mappable: indicated location within the presentation of the exam item; number of separate times the indicated location is logged; duration of gaze fixation upon the indicated location; interval of other logged location indications intervening between logging the indicated location and logging a second indicated location; and interval of time between logging the indicated location and logging a second indicated location.

According to some embodiments, the profile is determined by machine learning based on input comprising exam item location indications.

According to some embodiments, the input exam item location indications are obtained from logging of behavior of one or more calibrating exam subjects.

According to some embodiments, the input exam item location indications are at least partially artificially synthesized.

According to some embodiments, the profile comprises at least one description of one or more indicated exam item locations, which at least one description, when the logged locations do not fit within a pattern described by the at least one description, is associated with an expectation of an incorrect answer.

According to some embodiments, the profile comprises at least one description of one or more indicated exam item locations, which at least one description, when the logged locations fit within a pattern described by the at least one description, is associated with an expectation of an incorrect answer.

According to some embodiments, fitting within a description comprises a degree of correspondence between the description and the logged locations sufficient to support the assertion of the association.

According to some embodiments, an answer to an exam item comprises an exam item response recorded by the exam subject for use in exam evaluation.

According to an aspect of some embodiments, there is provided a method of detecting deviation from a target exam-taking strategy, comprising: logging locations within the exam item indicated by gaze directions of an exam subject toward a presentation of the exam item; classifying automatically the logged locations using at least one location profile adapted to classify logged locations to a classification of exam-taking strategy; and indicating deviation from the target exam-taking strategy, based on the classifying.

According to some embodiments, the indicating comprises providing the exam subject feedback describing the deviation.

According to some embodiments, the indicating comprises providing the exam subject feedback configured to elicit a return by the exam subject to the target exam-taking strategy.

According to some embodiments, the indicating comprises recording a notification of the deviation.

According to some embodiments, the profile comprises at least one description of one or more indicated exam item locations, which at least one description, when the logged locations fit within a pattern described by the at least one description, is associated with a deviation from the target exam-taking strategy.

According to some embodiments, the profile comprises at least one description of one or more indicated exam item locations, which at least one description, when the logged locations fit within a pattern described by the at least one description, is associated with a deviation from the target exam-taking strategy.

According to some embodiments, fitting within a description comprises a degree of correspondence between the description and the logged locations sufficient to support the assertion of the association.

According to some embodiments, the logging of gaze direction-indicated locations within the exam item comprises automatic tracking of eye movement of the exam subject.

According to some embodiments, the logging comprises recording when the exam item locations are indicated.

According to some embodiments, the at least one location profile comprises at least one event description, and the classifying comprises mapping the indicated exam item locations to the at least one event description.

According to some embodiments, the at least one event description comprises a range of one or more of the following parameters: indicated location within the presentation of the exam item; number of separate times the indicated location is logged; duration of gaze fixation upon the indicated location; interval of other logged location indications intervening between logging the indicated location and logging a second indicated location; and interval of time between logging the indicated location and logging a second indicated location.

According to some embodiments, the profile is determined by machine learning based on input comprising exam item location indications.

According to some embodiments, the input exam item location indications are obtained from logging of the behavior one or more calibrating exam subjects.

According to some embodiments, the input exam item location indications are at least partially artificially synthesized.

According to an aspect of some embodiments, there is provided a method of interfering with cheating on an exam by an exam subject, comprising: determining a location within a display area of the exam item indicated by the gaze direction of the exam subject; and altering the presentation of the exam item according to the location.

According to some embodiments, a correct presentation of the exam item is perceivable at the location.

According to some embodiments, an incorrect presentation of the exam item is perceivable outside the location.

According to some embodiments, the determining and altering are repeated as the indicated display area changes.

According to an aspect of some embodiments, there is provided a method of adjusting the difficulty of an exam item, comprising: logging, from each of a plurality of calibrating exam subjects, exam item locations selectively indicated by gaze direction; determining, based on the logged exam item locations, the effect of the exam item content at one or more locations on the likelihood of a correct exam item response being recorded by the calibrating exam subject; and adjusting the exam item, at a location implicated by the determining.

According to some embodiments, the determining comprises noting a correlation between gaze indications of an exam item location and providing an incorrect answer.

According to some embodiments, the determining comprises noting a correlation between gaze indications of an exam item location and providing a correct answer.

According to an aspect of some embodiments, there is provided a method of evaluating the strategy by which an exam subject determines an answer to an exam item, comprising: logging locations within the exam item indicated by gaze directions of an exam subject toward a presentation of the exam item; classifying automatically the log locations using at least one location profile adapted to classify logged locations to a classification of exam strategy; and indicating the exam strategy, based on the classifying.

According to some embodiments, the indicated exam strategy comprises cheating.

According to some embodiments, the indicated exam strategy is at variance with a targeted exam strategy.

According to some embodiments, the indicated exam strategy is a targeted exam strategy.

According to some embodiments, the logging comprises recording gaze direction over time by a gaze tracking apparatus.

According to some embodiments, the classifying is performed by a processor.

According to some embodiments, the indicating comprises automatic operation of a computerized user interface device to signal the exam strategy.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon. Implementation of the method and/or system of embodiments of the invention can involve performing or completing selected tasks manually, automatically, or a combination thereof.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example, and for purposes of illustrative discussion of embodiments of the invention. In this regard, the description taken with the drawings makes apparent to those skilled in the art how embodiments of the invention may be practiced.

In the drawings:

FIG. 1 is schematic representation of a testing system for relating attention and/or behavior during an exam to exam performance, according to some exemplary embodiments of the invention;

FIG. 2A is a schematic representation of a combined examination/monitoring environment where exam administration comprises use of a computer-controlled display and/or input means, according to some exemplary embodiments of the invention;

FIG. 2B is a schematic representation of a combined test/monitoring environment where test administration comprises a monitored exam device and marking means, according to some exemplary embodiments of the invention;

FIG. 3A is a schematic representation of a region-labeled text-based exam item providing multiple choice responses, according to some exemplary embodiments of the invention;

FIG. 3B is a schematic representation of a region-labeled text-based exam item, according to some exemplary embodiments of the invention;

FIGS. 3C, 3D and 3E show an exemplary pattern of attention-related behavior in relation to a multiple-choice exam item, according to some exemplary embodiments of the invention;

FIG. 4A is a region-labeled representation of a labeled figure comprised in an exam item, according to some exemplary embodiments of the invention;

FIG. 4B is a region-labeled representation of symbolic, non-textual elements (musical notation) comprised in an exam item, according to some exemplary embodiments of the invention;

FIG. 5 is a region-labeled representation of symbolic, non-textual elements (a map and annotations) comprised in an exam item, according to some exemplary embodiments of the invention;

FIG. 6 is a schematic flowchart representing activities related to attention monitoring while an exam subject answers an exam item, according to some exemplary embodiments of the invention;

FIG. 7 is a schematic flowchart representing activities related to attention monitoring integrating data from several exam items, and/or a whole exam, according to some exemplary embodiments of the invention;

FIG. 8 is a schematic flowchart representing automatic determination of a pattern template for use in monitoring examination performance, according to some exemplary embodiments of the invention;

FIG. 9 is a schematic flowchart representing manual and/or combined manual and automatic determination of a pattern template for use in monitoring examination performance, according to some exemplary embodiments of the invention; and

FIG. 10 is a schematic flowchart representing quality assurance testing for an examination, based on attention monitoring of a sample of examinees, according to some exemplary embodiments of the invention.

### DESCRIPTION OF SPECIFIC EMBODIMENTS OF THE INVENTION

The present invention, in some embodiments thereof, relates to the field of tracking behavior to determine attention, and more particularly, to tracking attentional behavior for monitoring of test performance.

### Overview

A broad aspect of some embodiments of the present invention relates to the monitoring of attention-related behavior accompanying performance of a task performance goal, to investigate the relationship between behavior observed, and task outcome.

An aspect of some embodiments of the present invention relates to the determination of a subject's engagement with a task, based on monitoring of eye movement and/or another behavior in relation to the elements of the task.

In some embodiments, the determination relates to a task where the meaning of a result depends on the path of events that reaches it. In some embodiments, the result comprises an answer to an exam item, and the path of events comprises attentional behaviors, such as eye movements and/or cursor movements.

In some embodiments of the invention, the task comprises providing an answer to an exam item. In some embodiments, a testing environment within which the exam item is administered comprises a computer configured for exam administration. In some embodiments, the testing environment comprises a behavior monitoring system. Optionally, the monitoring system comprises a video monitoring system. Optionally, the monitoring system comprises an eye tracking system. Optionally, the system comprises means for tracking and recording cursor movements and/or timing, key presses and/or timing, and/or monitoring of another input device used within the testing environment.

In some embodiments of the invention, the determination produces a result indicating subject engagement, subject non-engagement, and/or an estimate of the likelihood and/or degree of at least one of either. In some embodiments of the invention, the determination relates to the character of the engagement: for example, engagement reflecting understanding, engagement reflecting confusion, and/or engagement reflecting one or more strategies for task completion, or a lack thereof. In some embodiments, the determination relates to a prediction of a likely action based on the character of the engagement. For example, attentional focus on an answer choice potentially predicts a likelihood that this choice will be selected; lack of well-patterned attentional focus on a question overall potentially predicts a likelihood of a wrong answer being chosen.

In some embodiments, eye movement is a source of behavioral input. In some embodiments, eye movement is used as an indication of subject attention. In some embodiments, eye tracking is performed with a resolution, and with sufficient additional information, to allow determination of which region of an exam item is being inspected at each sample point in time. Such transformation of eye position to a determination of a position in the presentation of an exam item comprises gaze tracking. In some embodiments, the inspected region is determined to comprise a particular a paragraph, line, sentence, word and/or letter. In some embodiments, the inspected region is determined to comprise a particular figure, or portion thereof. In some embodiments, the inspected region is determined to comprise another particular element of an exam item, for example, a particular choice of a list presented with a multiple-choice exam item.

In some embodiments, eye movement is correlated with exam item events in time. For example, in some embodiments, an element of an exam item comprises an animation, video, and/or another moving or transforming element. Attention to a particular region of a display presenting such a dynamic element is determined, in some embodiments, by attentional behavior directed to a particular place at a particular time.

In some embodiments, conversion of attentional behavior measurements (for example, a log of eye tracking) into an indication of engagement comprises classification of the behavior measurements. The classification is optionally according to a profile. The profile optionally comprises one or more elements which are applied to categorize based on the occurrence, order, timing, and/or other features of attentional behaviors. In some embodiments (for indication of engagement, and, in some embodiments, for other uses of profiles as described herein), elements of a profile specify at least one criterion, for example: one or more regions of a presented exam item; one or more durations, latencies, and/or orders in which regions are targeted by attentional behavior; one or more regions away from a presented exam item, a number of times that a region is targeted by attentional behavior, and/or another criterion against which attentional behavior is evaluated. Element criteria are, for example, absolute (matching or not), graded (for example, according to a strength, intensity, duration, or other value), and/or probabilistic (for example, expressing a likelihood and/or confidence level). A profile or profile element optionally includes a classification associated with one or more of its criteria, for example, but not limited to: cheating, not cheating, attentive, non-attentive, or any other classification, for example as described herein. The classification is optionally absolute, graded, and/or probabilistic.

An aspect of some embodiments of the present invention relates to the use of a determination of subject engagement with a task as a basis for a further determination that the subject is potentially performing the task outside of required constraints. Detection of cheating on a test is an example of such a determination.

In some embodiments of the invention, the task comprises providing an answer to an exam item. In general, an exam item comprises a prompt for which a response is expected. The prompt can have sub-components such as options, instructions, background, figures, or other elements, for example as described in relation to the figures and other examples hereinbelow. The response length can range from atomic (a single selection of an option, for example) to an open-ended response, such as an essay. The response can be of one or more parts. The prompt is typically in the form of an express or implied question. A question is implied, for example, by an empty blank, by provided instructions, by the circumstances of the presentation of the exam item, and/or by a presented inconsistency or circumstance which is intended to elicit an exam item response. The answer to the exam item is typically subject to evaluation. For example, it is scored as a correct or incorrect, or ranked in completeness, accuracy and/or quality by another method such as a number of points.

An exam item response is typically an answer provided to the express or implied question. The form of the response can be a written or typed answer (with or without a selection of options to choose from), a mark, button press, another indication of an option, and/or any other signal from the exam subject that specifies a response to the exam prompt. The answer of to the prompt of an exam item is typically subject to scoring, for example, as right or wrong, or on a scale indicating quality and/or correctness. When the test subject provides an answer, it is typically, but not necessarily, an intentionally provided answer: for example, by performing one or more particular actions that designate the answer as an answer. Such actions can include, for example, marking the answer in a particular place, selecting (for example, by a computerized input device) a particular area of a display, and/or providing an answer, for example, to a verbal question, by responding using normal conversational conventions. Formats of exam item presentation are typically visual, sometimes auditory, but potentially including any presentation.

Exam items are typically administered in the context of an overall exam, which may comprise one, but usually a plurality of exam items. Answers to exam items are often independent of one another, each having its own separate prompt and answer. Exam items can be combined, however, with multiple answers expected for a single prompt, a provided prompt being interspersed with questions, or another form of mixing prompt and response. Other information shared among different exam items can include instructions, for example. Exams are typically evaluated; for example, with a score. The score can be simply a pass or a fail. Some exams have multiple score values possible within a single range, and/or are scored on a plurality of ranges. Evaluations of exam items are typically combined in some fashion to arrive at an overall exam score. In some exams, a subjective score adjustment is added, but this is preferably avoided in formal exams. The weighting of exam items within an exam toward an overall exam evaluation can be identical, but weighting can also be varied according to criteria such as importance or difficulty. For some exams, a scheme is used which seeks to make a correction and/or achieve a particular statistical profile. Examples of such schemes include calibration of scores to a normalized curve and/or penalties or other adjustments to compensate for the effects of guessing. Herein, “exam item”, “exam”, and similar phrases are interchangeably referred to, for example, as “test item” or using another “test” phrase, except where a distinction is explicitly made.

In a typical test situation, a test subject is supposed to provide an answer with restrictions on how the answer is arrived at. Evading such restrictions is generally treated as cheating, subject to sanctions such as invalidation or adjustment of the exam score, banning of the exam subject, or another action, which is usually intended to protect the validity of the test and/or punish the cheater.

Cheating can be by different means, and against different forms of restriction, usually accompanied by an attempt at subterfuge. In a typical test situation, a test subject is supposed to provide an answer with restrictions on the use of external assistance—disallowing, for example, assistance from another person and/or from an external reference. Varied according to the rules of an exam, a disallowed external reference may comprise, for example, the input of another person, notes and/or another document, a smartphone or other computational device, and/or a signaling device (such as a worn vibrating signal).

Cheating on these constraints is possible in a video-monitored testing environment, for example, by prompting from off-camera, prompting in an earpiece, use of concealed notes, or another method. Even in a human-monitored testing environment, cheating is possible by one or more of these means.

Typical exam restrictions also relate to forbidding use of foreknowledge of the test questions which bypasses mastery of the test material as such. For example, using a memorized answer pattern for a multiple choice test is a form of cheating which relates to the attentional behavior of a subject, even though no restricted source of answers is present during testing. Although exams can potentially be designed with features that prevent the effective use of such strategies, exam security is verified, in some embodiments, by monitoring of attentional behavior. In some embodiments, use of attentional behavior monitoring obviates the need for scrambling of exam items and or exam item elements among different subjects. This is a potential advantage, for example, when the order of presentation is relevant to the exam item's meaning, and/or preserving fairness among test subjects.

In some embodiments, a subject with behavior (for example, gaze behavior) which matches, and/or does not match a classifying profile of behavior with respect to exam item engagement is determined to be potentially using a source of information not allowed within the rules of the examination (cheating). For example, a subject apparently studying an exam item before providing an answer is found—upon analysis of behavior such as eye movement—to be relating to its elements differently than a subject who is legitimately studying the item itself. Differences on which a classification profile is based optionally include complete inattention, attention which does not appear as a behavioral pattern reflecting an attempt to comprehend the exam item, and/or attention which potentially reflects typical test taking behavior, but is inconsistent with the answers actually provided. In some embodiments, a difference includes slow scanning (reading) of an exam item—potentially reflecting poor command of the exam language—while the answers themselves reflect good command of the exam language. In some embodiments of the invention, determination of a “normal pattern” comprises recording of responses of the same subject that is being evaluated, under conditions where the exam item is likely to elicit a dependable type of behavior—for example, presentation of a very easy, a particularly hard, or even an irrelevant test item or other presented item. Optionally, this is used to provide one or more same-subject baselines of exam item engagement. Same-subject baselines are potentially more readily comparable to performance on items for which performance is actually being evaluated, because they tend to factor out inter-subject differences in behavior (for example, timing and/or spatial offsets of saccades).

In some embodiments of the invention, there is a reasonable chance to provide a correct answer by chance, even if an exam item is not understood. This applies, for example, to multiple choice exam items. It is thus possible, on a particular exam item, for an exam subject to honestly (if accidentally) provide a correct answer without first demonstrating a pattern of attentional behavior which indicates understanding of the exam item content. In some embodiments, a determination to distinguish between correct guesses and outright cheating comprises evaluation of the likelihood of a particular pattern of answers and behaviors, optionally provided over two or more exam items, all exam items, or another specification of exam item number. Optionally, where performance sufficiently exceeds that expected by chance, in cases where attentional behavior appears to sufficiently exclude the likelihood of informed choice, a judgment of potential cheating is made. The threshold of acceptable chance performance is, for example, p<0.05, p<0.01, p<0.001, or another greater, smaller, or intermediate p value.

Optionally, the p value, or another statistical measure, is applied to derive a level of confidence that cheating is occurring. It is to be understood that while cheating is generally aimed at the choice of a correct answer, there is a potential for at least occasionally unsuccessful cheating. In some embodiments, a behavior is marked as sufficiently distinctive (for example, a fixed stare at every exam item, or a repetition of a behavior that appears to co-occur with successful cheating) as to indicate a systematic attempt to cheat, even when at least some individual responses are erroneous.

In some embodiments, subjects who are determined to have exam results inconsistent with their attentional behavior are asked to retake the exam under more direct supervision. Optionally or alternatively, another indication of cheating is made; for example: an adjustment to the evaluated exam score, a change in the testing conditions, an alert to a test supervisor to intervene, and/or an alert to the test subject that they are under scrutiny.

An aspect of some embodiments of the present invention relates to the use of a determination of subject engagement with a task as a basis for evaluating performance of the task itself.

In some embodiments, a wrong answer on an exam item is potentially preceded by generally appropriate inspection of the exam item, indicating an engaged thought process, even if the provided answer itself is wrong. In some embodiments, behavior indicates that a correct answer was understood, but a wrong answer was provided for some other reason. Optionally, these aspects of exam behavior are consulted in exam item scoring, allowing assignment of partial credit even for mistaken answers, and/or providing a basis for appealing a mistaken answer during the test.

Additionally or alternatively, a correct answer, provided when the behavior pattern establishes that the exam question itself was not adequately engaged with, potentially indicates a lucky guess. In some embodiments of the invention, a correct answer after guess-like behavior is scored lower than a correct answer before which the question has been adequately considered.

In some embodiments of the invention, exam items comprising parallel structuring among their elements are presented. Failure to engage such parallel items with corresponding parallel patterns of attentional behavior potentially indicates that one or both of the items has not been adequately considered.

In some embodiments of the invention, a task is performed which, in order to be correctly performed, entails characteristics of attentional behavior. Potentially, a “correct” answer is unavailable for comparison, and/or is obtained only with some additional cost, such as a separate evaluation. In such cases, it is potentially valuable to evaluate task performance based on attentional behavior.

In some embodiments, a task in which human judgment is needed to identify image features is performed. Examples of such tasks include feature detection for security, intelligence gathering, defect detection, and/or keyword tagging. Other visual tasks potentially requiring human attention, but without a predetermined correct answer, include, for example, quality control of a text, and/or attention to a video monitor feed.

In some embodiments of the invention, workers are potentially of variable or unknown quality; for example, a task, in some embodiments, is “farmed out” to a distributed network of workers. It is a potential advantage to be able to determine that a worker is adequately scanning each image presented. Failure to adequately scan potentially indicates deliberate inattention (an attempt to “game the system”), but can also indicate fatigue, or a problem with the system. Detecting any of these is potentially of value for determining the value of provided results. Detecting the differences between any of these is potentially of value for determining the value of the worker as such—a tired worker potentially remains valuable for later evaluations, while a deliberate cheat makes themselves less attractive for future assignments. Additionally or alternatively, a worker demonstrating inability or otherwise “honest” failure to perform a particular task correctly is distinguished from a deliberate fraud. This is potentially useful, for example, if the tractability of the task is itself a matter of investigation. An honest failure to detect a hidden target in an image, for example, is potentially distinguishable from mere lack of effort. In some embodiments of the invention, the effect of cognitive loading and/or stress is verified and/or evaluated by monitoring of attentional behavior. In some embodiments, determining a response to a task item comprises evaluating a response under conditions of deliberately induced stress and/or cognitive load. Optionally, the evaluation comprises verification that a particular level of stress and/or cognitive load was present during the task. In some embodiments, cross-checking among workers is used to maintain quality of results. However, it remains a potential advantage to have a separate metric of result quality, for example to allocate available cross-checking effort most effectively.

In some embodiments of the invention, exam items comprise survey items. While there is no correct answer designated for a survey item, it is of potential value to be able to determine which survey items were answered genuinely, and which were answered with too little attention to be of value in compiling survey results. A pattern of attentional behavior reflecting engagement with the survey question is used, in some embodiments, to weight the value of the response.

In some embodiments, an attentional behavior pattern is itself used in the evaluation of a survey item response. For example, a product survey is aimed, in some embodiments, at a relative ranking of alternative product package designs under consideration. An exemplary question asks to pick the product out from a lineup of products, with the design of the product package being varied in different versions of the exam item. Potentially, the pattern of attentional behavior (for example, gaze dwell time on the correct choice, before correctly answering the question) reveals information about the relative distinctiveness and/or attractiveness of the tested product design. In some embodiments, performance of an ostensible task (for example, answering a survey question) serves as cover for an evaluation of another parameter (for example, whether and/or to what degree a particular element presented together with the task elements draws attention, potentially even if not related to the focus of the task).

In some embodiments, a combined survey/exam item is designed such that a subject's attention is engaged in providing the answer (potentially, there is a correct answer), but the answer itself is potentially irrelevant. For example, an image is visually searched to find the answer to an exam question, but the information of relevance to the survey aspect of the task is the distracting effect on attention of a representation of a product design within the image.

In some embodiments, conversion of attentional behavior measurements (for example, a log of eye tracking) into an indication of task performance comprises classification of the behavior measurements. The classification is optionally according to a profile. The profile optionally comprises elements which are applied to categorize based on the occurrence, order, timing, and/or other features of attentional behaviors. Available categories optionally include, for example, fatigued, distracted, non-engaged, non-performant (not doing the task), incorrect-performant, confused, and/or performant (correctly and/or as expected).

An aspect of some embodiments of the present invention relates to the use of a determination of subject engagement with a task as a basis for training and/or correction of task performance behavior.

In some embodiments, a pattern of engagement is related to a strategy for undertaking the task. In some embodiments, a subject who is attempting to improve their overall test taking approach is evaluated for their use of test taking strategies which correlate with particular behaviors during consideration of exam item answers. For example, reference to each item in a multiple choice test before selecting an answer is evaluated; failure to do so potentially causes a subject to miss the correct answer when “more than one of the above” or a similar test answer is available. Also for example, lingering on one or more elements of the exam item is noted, potentially indicating an underlying lack of understanding.

In some embodiments, a subject is monitored for attentional behavior which is inadequate, atypical, and/or matches characteristics of “problematic” attention. In some embodiments, corrective feedback is performed during task performance. For example, a subject is encouraged to reconsider their answer, and/or provided with a hint to redirect their attention pattern. In some embodiments, a test proctor is notified in order to provide personal correction. In some embodiments, a subject displaying signs of nervousness, exhaustion, and/or distraction is, for example, encouraged to rest, flagged for attention by a test proctor, presented with an audible or visual alert, and/or provided with another notification or intervention. A potential advantage of alerting a subject to their own lapses in attention is to improve performance as such. Another potential advantage is to help ensure, for the purposes of performance evaluation, that a subject is performing at their best level. In some embodiments, a subject is evaluated for displaying attentional behavior comprising repeated, consistent, and/or compulsive distraction from a target task.

In some embodiments of the invention, evaluation and/or feedback is delayed until after a full exam is performed. Optionally, the subject receives strategy hints tailored to particular features of their overall task behavior, allowing, for example, repeated errors to be singled out for emphasis.

In some embodiments, conversion of attentional behavior measurements (for example, a log of eye tracking) into an indication as a basis for training and/or correction comprises classification of the behavior measurements. The classification is optionally according to a profile. The profile optionally comprises elements which are applied to categorize based on the occurrence, order, timing, and/or other features of attentional behaviors. Available categories optionally include, for example, fatigued, distracted, non-engaged, non-performant (not doing the task), performant according to a preferred or non-preferred pattern of attention, confused, and/or performant (correctly and/or as expected).

An aspect of some embodiments of the present invention relates to the use of a determination of subject engagement with a task as a basis for adjusting the task itself.

In some embodiments of the invention, an exam item is itself evaluated in conjunction with attentional behavior monitoring of a subject population. Potentially, aspects of the exam item design which are unintentionally confusing or distracting are thus revealed. For example, a term which is lingered on by subjects potentially reveals an underlying ambiguity in the test item which was not intended.

Before explaining at least one embodiment of the invention in detail, it is to be understood that the invention is not necessarily limited in its application to the details of construction and the arrangement of the components and/or methods set forth in the following description and/or illustrated in the drawings. The invention is capable of other embodiments or of being practiced or carried out in various ways.

### Exemplary Exam-Monitoring Systems

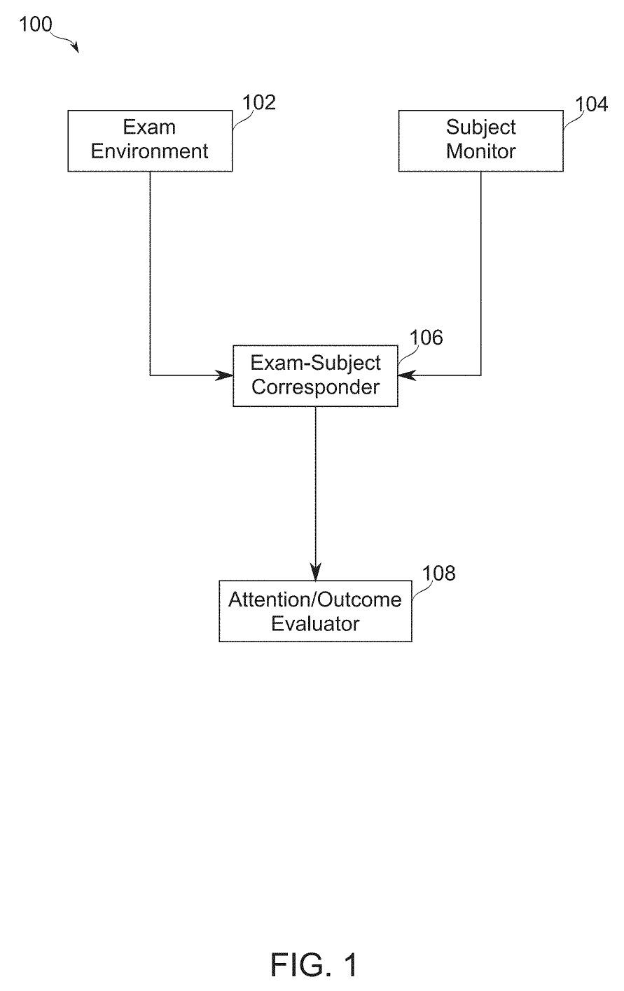

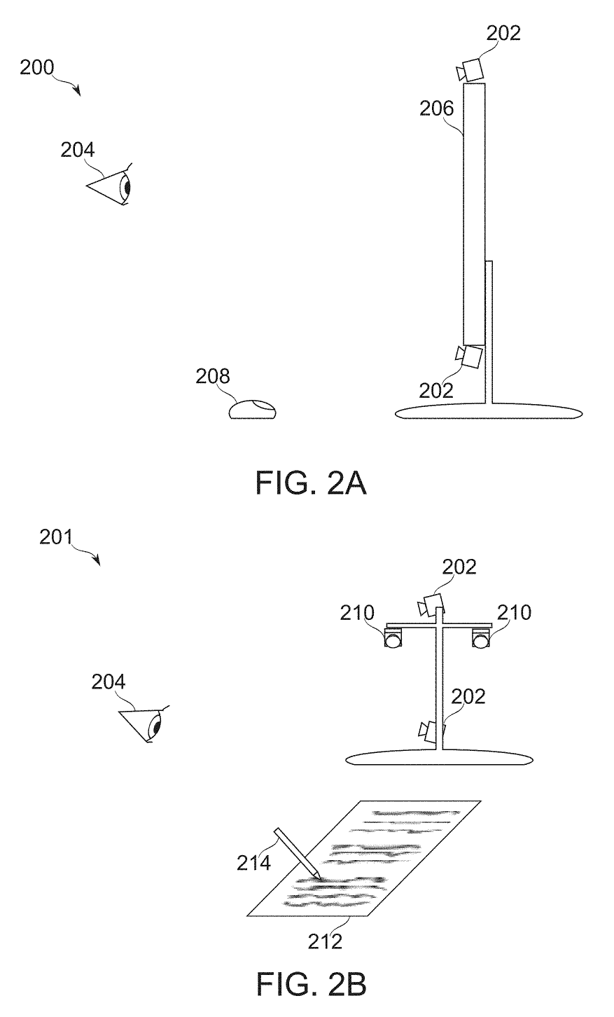

Reference is now made to FIG. 1, which is schematic representation of a testing system 100 for relating attention and/or behavior during an exam to exam performance, according to some exemplary embodiments of the invention. Reference is also made to FIG. 2A, which is a schematic representation of a combined examination/monitoring environment 200 where exam administration comprises use of a computer-controlled display 206 and/or input means 208, according to some exemplary embodiments of the invention. Further reference is made to FIG. 2B, which is a schematic representation of a combined test/monitoring environment 201 where test administration comprises a monitored exam device 212 and marking means 214, according to some exemplary embodiments of the invention.

In some embodiments, a controlled and/or monitored exam environment 102 is provided within which the exam is presented to a subject taking the examination. In some embodiments, the degree of control and/or monitoring is sufficient to allow calibrated correlation of the position of an exam item (and/or element thereof)—presented on a computerized display 206 or a position-monitored exam device 212—with the relative position and/or orientation of a test subject (in particular, the position and orientation of subject eye 204).

It is a potential advantage to use a computer-driven display 206 as the exam item display means, as this allows relatively straightforward position calibration of attentional behavior monitoring device 202 (such as a video monitoring device) relative to the position of the exam item. For example, behavior monitoring device 202 can be directly mounted to the display. Computerized control of presentation also potentially simplifies recording of which item is presented, where, and/or when. Another potential advantage of the use of a computerized display for exam item presentation is to allow on- or near-item feedback to be presented to an exam subject as exam items are engaged with. In some embodiments of the invention, a computer-driven display 206 (optionally including attentional behavior monitoring device 202) is in turn directly mounted to the subject taking the examination, for example, as part of a virtual- and/or augmented-reality display.

A computer input means 208 for entering exam responses is provided with the test environment in some embodiments of the invention. Exam responses are provided, in some embodiments, by standard computer input hardware, such as a mouse or other pointing device, a keyboard, a touchpad, a gesture recognition system, or by any other computer input means.

Additionally or alternatively, a test environment, in some embodiments, comprises a monitoring device 210 for a separately moveable exam presentation device 212. The exam presentation device 212, in some embodiments, is a test paper. This is a potential advantage for a situation wherein computerized monitoring is available, but test administration is preferably done on using paper. Use of paper allows, for example, use of an exam item designed outside of the constraints of a computerized environment, and/or automatic monitoring along with handwritten response elements. In particular, an exam item optionally comprises manipulation and/or examination of a 3-D object, or simply of a paper which an exam preparer has written out by hand. Optionally, evaluation of “shown work” comprises part of the scoring. It is a potential advantage to allow an exam subject to enter such work without artificially distinguishing between the final answer, and the process of arriving at it.

In some embodiments, the exam presentation element 212 is a computerized display similar to display 206, but it is outside the direct control of the test monitoring system as such. Even in embodiments for which both test administration and test monitoring are computerized, it is a potential advantage for test monitoring to be adaptable to a separately provided test administration means, for example, to provide greater flexibility of choice in testing platform while preserving the function of automatic monitoring. In some embodiments, there is coordinated control of exam presentation and exam monitoring, but relative spatial positioning is provided by separate monitoring of the relative position of subject and exam, rather than by fixing presentation and monitoring means together.

The monitoring device 210 is, for example, a video camera, a touch-sensitive surface, an acoustic locating device, or another means for determining the position of an object in space. The monitoring device 210 is configured in some embodiments, to determine the position of the test paper 212. As shown in FIG. 2B, monitoring devices 210 and 202 are provided in fixed spatial calibration, but it is to be understood that they are optionally calibrated separately, and/or calibrated on the fly, for example, with reference to a calibration object. Additionally or alternatively, monitoring devices 210 and 202 optionally comprise a common monitoring means, for example, one or more cameras having a wide angle viewing lens.

In some embodiments, the monitoring environment 201 also tracks a marking means 214, such as a pen, pencil, or stylus. Optionally, repositionable exam presentation means 212 and/or marking means 214 are provided with a machine trackable feature, such as an alignment mark, bar code, RFID chip, magnetic coil, or another feature, the use of which is comprised in automatic determination of exam item and/or exam response position.

In some embodiments of the invention, a subject monitor 104 is provided which operates to monitor behavior and/or attention of an exam subject during consideration of an exam item. In some embodiments, the subject monitor 104 is configured to monitor attentional behavior. More particularly, gaze direction is monitored in some embodiments. In some embodiments of the invention, gaze direction defines a direction in space which, passing from the vicinity of the subject's eye, intersects with the region of an exam item to which attention is currently directed. In some embodiments of the invention, another source of input is used to receive information about the attentional focus of a subject. For example, the position of a screen cursor, digit, pen/pencil/stylus tip, or another “pointer” under the control of the subject is monitored. In some embodiments of the invention, attention to elements of a test item (for example, an audibly presented test item) is determined from a pattern of requested presentation. In some embodiments, attentional monitoring comprises monitoring of brain state, for example, of EEG pattern and/or by functional brain imaging such as by fMRI. In some embodiments, attentional monitoring comprises monitoring of sub-vocalization behaviors of the mouth and/or pharynx.

In some embodiments of the invention, a monitoring device 202 comprises a video camera directed so that the eye of a test subject is visible with sufficient resolution (and other positional information, such as head position and orientation) to allow gaze direction determination. In some embodiments, another eye position monitoring means is used, such as a scleral search coil.

In some embodiments of the invention, an exam-to-subject corresponder module 106 for determining spatial and/or temporal correspondence between behavior/attention and exam item elements is provided. In general, correspondence module 106 operates to integrate information about the exam environment and the monitored subject, allowing determination of the region of the exam item which receives attention during a given period. In some embodiments a determination of a region of attention is modulated by a non-spatial cue, such as a level of monitored brain and/or motor activity.

For clarity of further exposition, descriptions herein relate to the “position” or “location” of an exam item or of an element thereof and/or therein, and treat attention also as having a “position” or “location” which corresponds to a region (spatial, temporal, or otherwise) of the exam item. It is to be understood that this is a conventional way to describe determination of attentional focus based on recorded data which is itself potentially at least partially non-spatial, and/or which has a directly determined “position” in another sense. For example, attention is spoken of as being at or to a word of an exam item, although the underlying situation potentially involves understanding of the relative positions of a subject and a presentation of an exam item, and the direction of a subject's gaze. A “position” or “location” can indicate particular recorded or calculated coordinates and/or coordinate ranges; additionally or alternatively, a “position” or “location” may indicate a less sharply delineated region, for example, a region of variably estimated likelihood that a particular exam item element, such as a word or phrase, is a focus of gaze and/or attention.

It should, moreover, be understood that the word “attention” is used to mean attention apparently given by a subject to a stimulus, insofar as it is inferred from monitored data, for example by means of a correspondence module 106. In the case of an examination monitoring system which relies primarily on eye movement and/or position for subject monitoring, the evaluation of “attention” comprises evaluation of the direction of gaze. In some embodiments, attention evaluation also comprises the intervals between saccades (and/or the length of fixations), and/or groupings of saccades into sequences having identifiable directedness and/or relatedness. For example, reading of a passage comprises sequences of short horizontal saccades in one direction with periodic return saccades in the other. In some exam items, saccade sequences link separated regions with interrelated meanings.

In some embodiments of the invention, a pattern of recorded attention to one or more exam items is converted to an attention/outcome evaluation by an evaluator module 108. In some embodiments, evaluation is by comparison of recorded attention with one or more templates which define characteristics of attentional patterns to which an event definition is assigned. For example, attention comprising gaze scanning over a set of instructions is assigned an event definition such as “subject reads instructions” (and/or a functional equivalent). Attention which alternates a number of times between exam item body and presented answer alternatives is assigned an event definition such as “subject is uncertain”. Attention which singles out a key word in the exam item body is assigned an event definition such as “subject notes keyword”. In some embodiments, an event definition comprises qualifier information, which describes, for example, a quantitative measure such as duration of attention (gaze fixation, for example) or frequency (number of times an exam item element is examined). Optionally, event qualifiers describe a level of certainty in the event classification and/or occurrence. Optionally, an event qualifier describes a level of intensity of a higher-order parameter, comprising, for example, “certainty”, “confusion”, “salience”, or another parameter. In particular, in some embodiments, a determination of “cheating” is built directly from low-level attentional behaviors (such as lack of engagement with an exam item at all, for example). In some embodiments, a determination of likely cheating is built from the occurrence (generally together with correct answers provided) of one or more higher-level behaviors, such as: consistent failure to read instructions, note keywords, or show a grasp of salience; and/or consistent display of confusion, uncertainty, or another “negative” pattern. It is to be understood that classification to an event can include binary (for example, “cheating” or “non-cheating”), probabilistic (“cheating” with a probability greater than some percentage of likelihood, for example), partial (“cheating” on some subset of a list of criteria), or another form of classification within a continuous or categorical range of outcomes.

Although discussion of exemplary embodiments in terms of “event definitions” is convenient for the sake of presentation, it is to be understood that, in some embodiments, there is no descriptive event definition provided, or an event definition that is provided only partially determines further action. In an exemplary scenario of a subject learning to improve test-taking skill, a binary flag is set when a subject's gaze enters a key region of an exam question. When the question is answered, the flag state is recorded, with or without special reference to it as an event as such. In some embodiments, a trained neural network embodies features of event definitions, without explicit specification of defined events as such. The invention should be understood to encompass all such variations of the specific embodiments described herein.

In some embodiments of the invention, determinations of an evaluator module are accumulated to a data structure suitable for transformation to a report. In some embodiments, determinations result in on-line actions, for example, the display of messages to the subject and/or to an exam proctor. In some embodiments, determinations are combinable to increase the certainty of a higher-order determination. For example, a determination on just one exam item that a pattern of inattention is matched is not sufficient to indicate that a correct answer is illegitimately provided. However, a case of repeated instances of inattention corresponding to correct answers potentially indicates cheating.

It is to be understood that calibration of a behavior tracking device is used, in some embodiments of the invention, in order to help ensure that recorded behavior is correctly related to inferred patterns of attention. In particular, eye tracking can be calibrated by use of calibration tasks performed before and/or at intervals during test item presentation. A calibration task, in some embodiments, comprises a relatively non-challenging task, such as looking at fixation targets within the field of vision under the guidance of specific calibration instructions. Calibration of a gaze tracker, in some embodiments, comprises calibration which relates attention to movements of the eye in the head, as well as movements of the head itself.

### Exemplary Exam Items

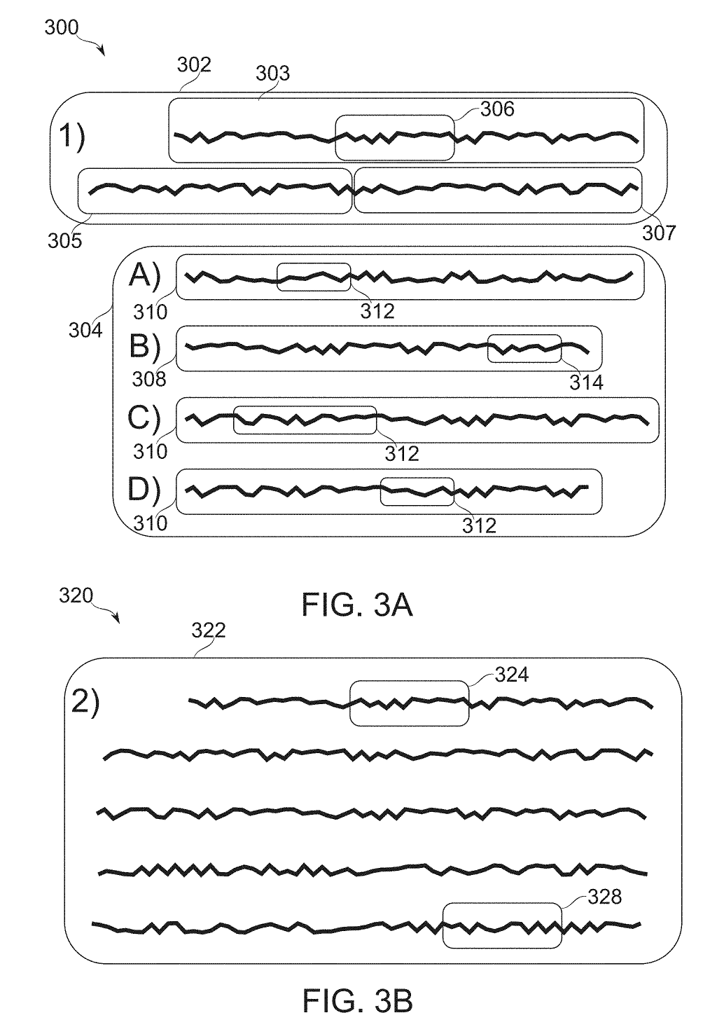

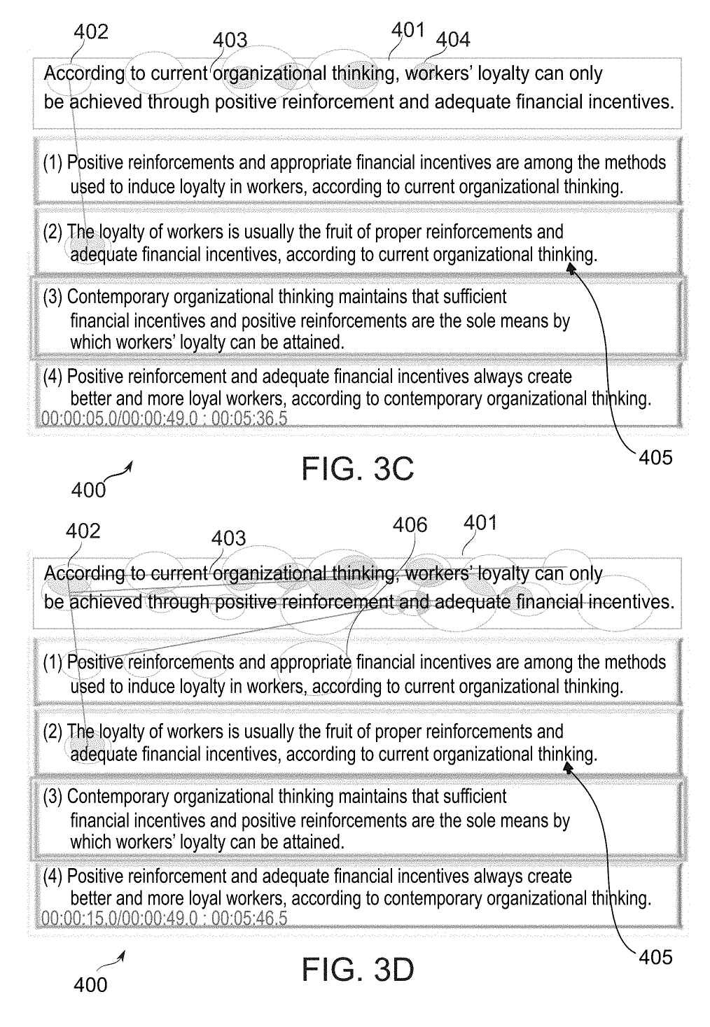

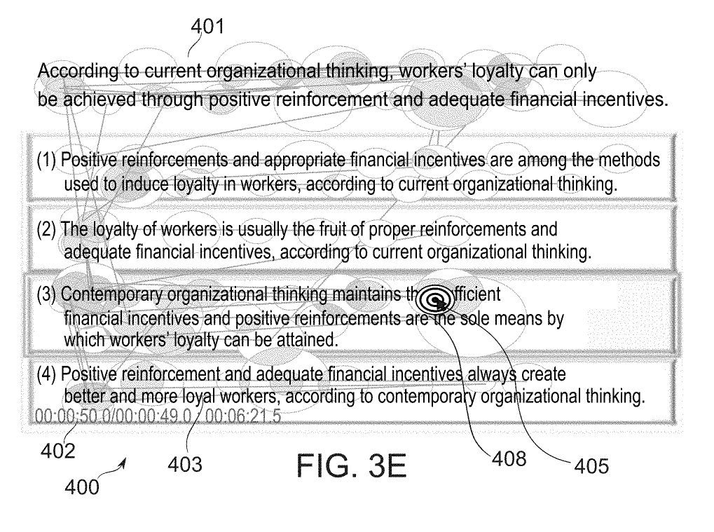

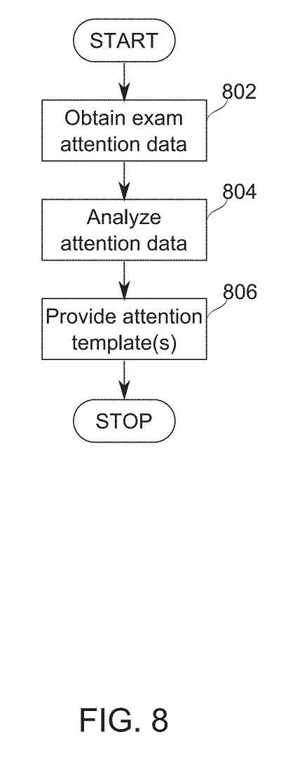

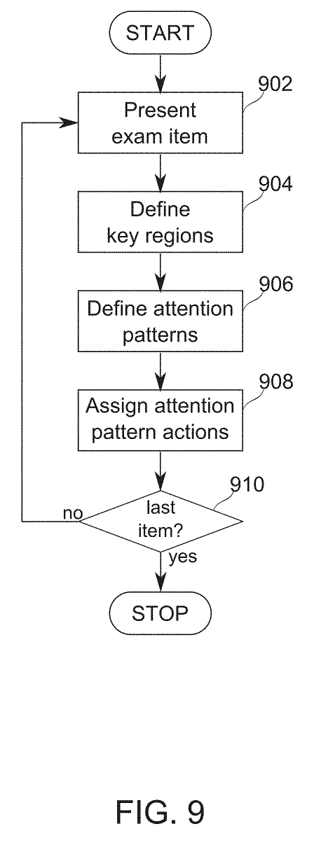

The discussions of FIGS. 3A-3B, 4A-4B, and 5 relate to qualitative determination of attention-evaluating rules for particular questions and/or types of questions, based on concepts such as “key element”, “instruction”, “question”, “background”, “response choice”, and/or meaningful relationships thereamong. Reduction of rules to event definitions specifying associated quantities (for example, number of attentional engagements, their lengths, and/or relative timings), is described, for example, in relation to FIGS. 8 and 9.

In some embodiments, a “rule” is implicitly arrived at. For example, a database of exam-time attention data is compiled, and used to automatically generate triggers relating to presently observed behavior, based on similarity to past observations. Optionally, this is performed without requiring input as to the “meaning” of a pattern as such, for example, through use of supervised and/or unsupervised automatic learning. Optionally, automatic determination relies on correlations, for example, between present behavior, and a variety of previously observed successful, unsuccessful, and/or cheating exam item attention engagement patterns. In relation to such embodiments, the “rules” of FIGS. 3A-5 serve to illustrate how such patterns are likely to arise, and/or to describe their features which serve as a basis for automatic recognition.

In some embodiments, a combination of automatic and manual recognition of relevant regions is performed. For example, a human exam preparer is presented with patterns of previously measured attention, and from clusters of attentional focus and/or links therebetween, singles out those which appear to be most relevant and/or meaningful.

Textual Exam Items

Reference is now made to FIG. 3A, which is a schematic representation of a region-labeled text-based exam item 300 providing multiple choice responses, according to some exemplary embodiments of the invention.

In FIG. 3A and elsewhere, the ragged lines represent textual material provided as part of an exam item, according to the accompanying descriptions of the labeled drawing elements. Enclosing boxes highlight, in a general way, regions of interest for discussion. FIGS. 3C-3E adopt conventions more typical of attentional behavior representations, and demonstrate an example of a specific test item and associated mapped attentional behaviors.

Exemplary multiple-choice exam item 300, in some embodiments, comprises a question and/or instruction region 302, and a response selection region 304. Responses 310 comprise various incorrect responses, while response 308 comprises a correct response.

Text region 306, in some embodiments, comprises a unit of text (word, phrase, sentence, and/or paragraph) containing key information, without which, the correct answer cannot be determined. Text regions 312 contain units of text which disqualify their containing responses from being the correct answer. Text region 314, in some embodiments, comprises a unit of text which is key to a direct understanding that response 310 is correct.

At least two distinct but related forms of question are addressable by some embodiments of the invention. First, based on the patterns of attention observed among the indicated regions of exam item 300: has the subject attended to the exam item elements appropriately to their roles in the question? This form of question is relevant, for example, to assist a student learning skills of test taking, and/or to evaluate the clarity of the exam item itself.

Second, and particularly if the subject has not related to a question appropriately: is the subject's attention pattern consistent with the answers provided? More particularly: is the subject cheating? In some embodiments, answering the second type of question depends on being able to answer the first, at least in some measure. However, in some embodiments, the first type of question is asked in detailed variations which go beyond the question of cheating, for example, to help determine how a subject can improve going about trying to understand exam questions in general.

In some embodiments of the invention, meaningful patterns of attention (or inattention) to an exam question are predefined, and used as a basis for comparison with attentional patterns actually recorded. Roughly stated, patterns categorize as answer-“matching”, “non-matching”, and “non-predicting” attention patterns. A “matching” pattern corresponds to a pattern of attentional engagement with a test item which is either observed to correlate, or expected to correlate with eventual provision of a correct answer. A “non-matching” pattern, in some instances, simply describes the lack of a critical “matching” pattern. In some embodiments, a “non-matching” pattern comprises a pattern of attentional focus which actually reflects inattention, reflects mental confusion, and/or (more operationally), is correlated with providing incorrect answers. A “non-predicting” attention pattern, in some embodiments, can comprise attention which is not captured by any of the defined patterns. In some embodiments, a recognized but irrelevant attention pattern is “non-predicting”, at least in and of itself; for example, saccades in or out of the overall exam item region. It is to be understood that a sequence of individually “non-predicting” motions potentially contribute to a “matching” or “non-matching” pattern when considered in the aggregate.

In some embodiments, patterns overlap and/or are built upon one another. It is also possible that a pattern of one class contributes to build up a pattern of another. For example, occasional saccades in and out of the exam item region are potentially innocuous or neutral, but repeated saccades potentially indicate the possibility that a subject is consulting a disallowed reference source.

Reference is now made to FIGS. 3C-3E, which show an exemplary pattern of attention-related behavior in relation to a multiple-choice exam item 400, according to some exemplary embodiments of the invention.

In FIGS. 3C-3E, positions of gaze fixation are indicated by the center position of ovals such as oval 402. In FIGS. 3C-3D, the last-viewed fixation positions shown are labeled as ovals 404, 406. Duration of fixation is represented by the area of each oval 402; increasing area corresponds to increasing duration of fixation. Overlapping ovals result in increased darkness of display. It should be noted that fixation position, in some embodiments, comprises an average or another statistically determined position for gaze position based on samples obtained during the fixation. Frequency of gaze position sampling is, for example, 30 Hz, 50 Hz, 60 Hz, 240 Hz, 350 Hz, 1000 Hz, 1250 Hz, or another higher, lower, or intermediate sampling frequency. Fixation regions are linked by saccadic movements, represented, in some embodiments, by saccade linking lines such as lines 403. Mouse cursor position 405 during exam item interaction includes a final position 408 at which a mouse click is used to signal the selection of the exam subject.

The instructions for responding to the exam item (not shown) are to choose the response item (1)-(4) which best rephrases the meaning of the prompt item 401. The pattern of gaze/mouse operation behavior shown in this example is summarized as follows: upon presentation of the exam item (FIG. 3C), the test subject takes only a few moments to orient, looking briefly at response element (2) until gaze shifts to the prompting item 401 at the top. Continuing to examine the exam item (FIG. 3D), the test subject finishes reading the prompting item 401, and continues with scanning response item (1). By the time exam subject is ready to answer the exam item (FIG. 3E), all four response elements have been scanned through at least partially. Evidence of back-and-forth scanning between response elements and the prompting item 401 is visible in the number of saccade lines 403 which connect the prompt item 401 to other elements. Furthermore, the test subject demonstrates expertise in ruling out response elements (2) and (4) with only a partial reading. Heavy attention paid to response element (3) is predictive of its eventual choice. In particular, the long fixation on the words “sole means” indicates awareness of the salience of these words to the determination of the correct response. Finally, response element (3) is chosen, as indicated by an input device click provided while the cursor overlies response element (3).

It is to be understood that, where a pattern of attention (in particular, gaze attention) is to be displayed in connection with some embodiments of the present invention, the display is of any suitable form; for example, a static gaze map and/or sequence of such maps as shown in FIGS. 3C-3E, an animated map, a heat map, a blind zone map, or another representation of attentional behavior.

Specific instances of exemplary patterns and accompanying scenarios are now described with reference to FIG. 3A.

In a first scenario, an expert exam taker engages attention appropriately with the exam item before identifying and providing a correct answer. Several “good” patterns are described.

The question region 302 and the response region 304 are scanned, and scanning of the question region 302 in particular is complete. The most thorough scanning of the response region 304 occurs after the most thorough scanning of the question region 302. If a question text region 306 is critical, then scanning of question region 302 will include it.

In the case of a simple, well-understood question, the subject scans each response 310, 308 until the correct answer is read, then stops, and answers the question. This pattern potentially provides a high degree of certainty that the subject has answered the item for themselves. Potentially, the pattern indicates high subject-matter engagement on the part of the subject, but, additionally or alternatively, it could indicate poor use of strategy, since the exam instruction may be to select the “best” item, and/or there may be a possibility of a “more than one of the above”-type selection.

Alternatively, each response 310, 308 is scanned, even once the correct response 308 is read. In this case, the certainty of comprehension is potentially lower, as the correct answer is not thereby singled out as salient. However, as a strategy, a full reading is potentially preferred. In some embodiments, salience is found, furthermore, based upon analysis of scanning behavior within one or more of the provided answers. For example, upon reaching a key text region 312, it is potentially apparent immediately to the subject that the response is incorrect. Rather than dwell on the item, the subject skips on.

The subject potentially returns to the correct response 308 upon reviewing all answers, for example, to verify an answer which was already understood to be correct. This in itself may not be considered as a positive indicator in a potential cheating situation, since this can be adopted as a conscious strategy. However, the scan is potentially more salient if it reads up to a critically meaningful part of the text, for example, key region 314, and then breaks off. Identifying and reacting to such critical words is harder for a cheating exam subject to mimic.

Apart from the selection of appropriate exam item regions to attend to, the pace of an expert test taker is typically rapid (from millisecond to seconds per item), and consistent. Irrelevant items and text regions are quickly disregarded, and less likely to be returned to even if initially read wholly.

On a question which a legitimately performing examination subject finds somewhat harder, the behavior pattern potentially switches into a “ruling out” mode. For example, two or more answers appear, on the basis of preferential attention paid to them, to be candidates for the right answer in the mind of the subject. This is potentially an indication of an appropriate strategy. It is also potentially mimicked by a cheating subject, but this is more difficult for questions in which only a subset of the answers are really worth considering. Furthermore, genuine indecision itself is expected to increase the likelihood of attention shifts to and/or away from regions of particular salience to the exam item.

When a legitimately performing examination subject is reduced to guessing (perhaps in concert with a “ruling out” strategy), hesitation is potentially evident in the decreased pace of switching among text regions. Attention is paid for a longer period to items under consideration, potentially with intermittent shifts back to salient regions of the question itself.

In some embodiments of the invention, a pointer device is tracked during exam item consideration. Particularly for a computer-entered exam, some exam subjects allow a pointing device to linger on a preferred option while verifying their choice. An unusual degree of mismatch between pre-selection and actual selection, in some embodiments, increases a likelihood of some form of cheating on the part of an examinee (exam subject). With greater confidence, mouse movements which follow the recorded attention of the subject provide an indication of legitimate engagement with the exam item material. In some embodiments, tracking mouse behavior allows, for example, division of a period of exam item consideration into two periods, where behavior in a second period—after an answer is pointed to—is more easily and/or confidently ascribed to a “verification” phase of the answer. While not every examinee naturally creates such a dividing mark, it is a potential advantage to for a subject being trained in test taking to be taught to use this as a self-reminder to check their work before finalizing their response. If this convention is adopted, a monitoring system can also, potentially, perform a more detailed and/or confident review of the trainee's verification skills as such, based on the clear indication of a shift in mode that the pre-indication provides.

Reference is now made to FIG. 3B, which is a schematic representation of a region-labeled text-based exam item 320, according to some exemplary embodiments of the invention.

In this example, there are no pre-determined choices assumed, only the text of the exam item 322 itself. Such a question is nevertheless like to have at least some key-word or key-phrase locations 324, 328 which meet one or more of the following criteria:
Needs to be read in order to understand the question.
Is more likely to be referred to, the longer that an exam subject takes to answer (term which is likely to be at the root of confusion, forgetting or misunderstanding).
Has an important conceptual, logical, and/or grammatical relationship with another keyword or key phrase, leading to switching between.

Roles of keywords and key phrases are also seen, for example, in relation to the exemplary exam item of the next section.

Exemplary Textual Exam Item

An exemplary multiple choice test question is now presented, demonstrating aspects of the above discussion in relation to a particular exam item.

In some embodiments of the invention, a question region 302 of an exam item is divided into two or more of a “background” section 303, a “question” section 305, and an “instruction” section 307. For example, a question region 302 having all these sections could read as follows:
“All known crows are black. All ravens are black by definition. Which of those two sentences asserts a priori knowledge? Choose the best available answer.”

In the example, the first two sentences comprise the background section 303, the third the question section 305, and the fourth, the answering instructions 307. It is a sign of comprehension when the attention pattern of an exam subject relates to these parts separately, according to their engagement with the question.

The two sentences about birds are similar in structure, with the key differences of “known” in one and “by definition” in the other. There is also an unimportant, potentially distracting difference: “crow” instead of “raven”. It is a potential sign of attempted comprehension to attend to (look at) either difference, as signaled, for example, by switching between the members of a contrasting pair of key words. A high-performing examinee, however, will quickly disregard the crow/raven distinction, and focus on the relevant distinction.

In the question itself, the term “a priori” comprises a key term; the question cannot be answered with comprehension unless that key term is attended to and understood. While a high-performing examinee potentially understands the term without returning to it, this should also be accompanied by rapid disposal of the exam item overall. An examinee who delays answering, without returning to this key word, is much less expected, and may be experiencing problems with comprehension, or simply not engaging with the exam material.

The instructions are generic, and likely to be repeated among several questions on one exam. There is expected, therefore, only a cursory scan of this sentence before answering the question. Nevertheless, an examinee who answers without looking at this sentence at all is potentially using a poor testing strategy. Although the instruction carries little information, it may be returned to by the exam subject in the case of ambiguity (in the structure of the exam item) and/or confusion (on the part of the subject). Thus, a second attentional reference to the instructions part-way through a long response time is a potential indicator of legitimate engagement with the question material.

The provided responses to the question could read as follows:
A) Neither sentence.
B) The first sentence.
C) The second sentence.
D) Both sentences.

As formulated, consideration of the right answer relies at least on remembering the background section 303 in detail. Particularly if the answer is not immediately evident, an examinee will potentially return to the background section 303 several times before an answer is determined. This is emphasized in this case because the answers A-D are written to refer to the first and second sentences of the background section 303. An engaged examinee is thus likely to link successive saccades between item B and the first sentence, and item C and the second sentence. These patterns of attention would, accordingly, tend to indicate correct exam item comprehension, as well as legitimate engagement with the material.

The question, as phrased, contains at least one potential ambiguity. While response C is intended (“All ravens are black by definition”), an examinee is potentially tempted to select response A (“Neither sentence”), reasoning that knowledge of a definition is itself not a priori. To resolve this, the examinee might refer to the instructions to choose the “best” answer. Although this is not a terribly clear instruction as it stands, an experienced exam taker is likely to recognize it as a reassurance that the question was not intended to be over-thought. Reading the question again, the word “asserts” instead of “is” might be noticed as a key word; the examinee then potentially dwells on this term for a period before supplying an answer.

Some of the above-described relationships and thought processes for the raven/crow question are only optional parts of a legitimate reasoning process that leads to a correct (or even an incorrect) answer. However, at least some of them are both likely to be seen in a process of legitimate reasoning leading to an answer, and difficult for a would-be cheater to mimic without actually understanding the question in the first place. In an instance leading to a legitimate mistake, (such as confusing the meaning of a priori and a posteriori), some different—but also potentially predictable—additional patterns are potentially seen. Some patterns should (for reasons of good exam-taking practice) be seen in a pattern of attention to the exam item during response, and if not, potentially indicate a need for further training in exam-taking.

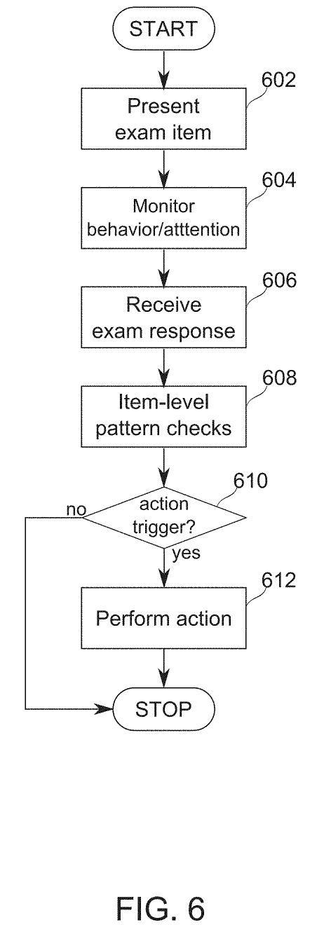

Furthermore, several of the patterns described are alternatively expressed as rules potentially suitable for machine recognition. Described patterns also relate to a potential meaning translatable into a machine action, for example as described in relation to FIGS. 6-7 and 10, hereinbelow. For example, a selection of rules relating to the above discussion would comprise, in some embodiments of the invention, rules described in Table 1:

TABLE 1

| REGION(S) INVOLVED | TYPE OF ENGAGEMENT | MEANING |
|---|---|---|
| known and by definition | saccade between | engaged, comprehending |
| raven and crow | saccade between | engaged, distracted |
| Response A and All crows . . . | saccade between | engaged, comprehending |
| Response B and All ravens . . . | saccade between | engaged, comprehending |
| Responses C & A, not B & D, and | slow examination | engaged, ruling out ambiguity |
| Instructions or asserts | | |
| 2 or more responses, but not C | slow examination | engaged, a mistake is expected |
| a priori | never read | not engaged |
| a priori | 2nd or further scan | engaged, not sure of definition |
| Response D | never read | weakness in exam-taking |
| | | technique |
| Instructions | never read | weakness in exam-taking |
| | | technique |

Herein, “saccade”, though a term which specifically relates to eye movements, should be also understood as relating to shifts of attention as such, for embodiments where another means is used to determine attentional focus.

In some embodiments, rules applicable to the content of an exam item, are derived, for example, from more general rules set out in Table 2, of which may of the rules of Table 1 are particular examples.

TABLE 2

| REGION(S) INVOLVED | TYPE OF ENGAGEMENT | MEANING |
|---|---|---|
| Instructions, Question, | wrong-ordering of attention | weakness in examination |
| Background | | technique |
| key element | never read | weakness in examination |
| | | technique |
| key element | long focus | engagement with exam item, |
| | | possible confusion |
| key element | repeated focus | engagement with exam item, |
| | | possible confusion |
| related key elements | saccade between | engagement with exam item |
| related key elements | multiple saccades between | engagement with exam item, |
| | | possible confusion |
| response choices | cycling saccades (possibly | engagement with exam item, |
| | interrupted) | attempt to eliminate/choose |
| response choices | cycling saccades (just before a | engagement with exam item, |
| | choice) | verification behavior |

Figurative/Symbolic Exam Items

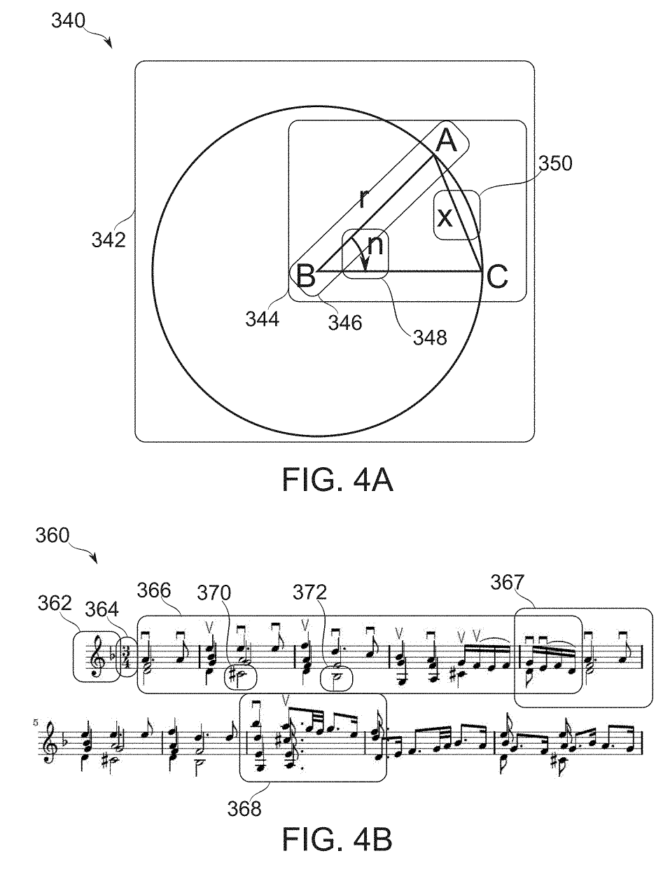

Reference is now made to FIG. 4A, which is a region-labeled representation of a labeled FIG. 340 comprised in an exam item, according to some exemplary embodiments of the invention.

In some embodiments of the invention, an exam item comprising a FIG. 340 is presented to an exam subject. In some embodiments, a FIG. 340 comprises a region 348, 350, 344, 346 comprising non-textual symbols. In some embodiments, a figure comprises regions 344, 342, 346 containing other graphic elements. In some embodiments of the invention, a figure region 346, 344, 342 comprises both symbolic and graphic elements.

These exam item regions (and/or the elements they comprise) are relatable to rules based, for example, on the rules of Table 2, for example as described in the following:

In some embodiments, non-textual symbols comprise key elements of an exam item, such that an exam subject must—or at least usually does—distinctly engage attention with the element in order to successfully answer the question. In the example of FIG. 4A, a question relating the symbols r, n, and x (for example, to express x in terms of r and n) should not be correctly answerable without engaging attention with each of these symbols (for example, regions 348, 350, 344). In some embodiments, the spatial relationships among symbols are themselves relevant. For example, the question “what is the length of segment AB”, might be expected to result in an attentional scan along the radius segment comprised in region 344. Long attention to region 344 potentially indicates confusion about the question. Excessive attention devoted to regions irrelevant to the question (for example, along segment BC, or outside of region 344) potentially indicates confusion, or even failure to meaningfully engage with the exam item.

Reference is now made to FIG. 4B, which is a region-labeled representation of symbolic, non-textual elements 360 (musical notation) comprised in an exam item, according to some exemplary embodiments of the invention.

In some embodiments of the invention, an exam item comprising a FIG. 360 is presented to an exam subject. In some embodiments, a FIG. 360 comprises musical notation. In the case of FIG. 4B, two lines of Bach violin Partita No. 2 are shown. Musical notation serves as a representative example of any non-textual, substantially symbolic representation which may be used to comprise an element of an exam item. Other examples include, for example, computer source file listings, and/or some forms of technical schematic.

Musical lines comprise several notational regions, each with a distinct role in the interpretation of the notation's meaning. According to the question asked, these potentially provide key regions which serve as a basis for attentional rule making. These include, for example, key signature 362, time signature 364, musical phrase 366, the region 367 where phrase 366 ends, a note 370 modified by an accident, another note 372, and musical climax 368. It should be noted that the key items relevant to a question will vary depending on the question asked. Unless the question is about a global property of the musical passage, the remaining symbols potentially represent distracters. In some embodiments, a distracter rule, potentially representing non-engagement with the exam material, is described as extended focus outside of the relevant regions of the exam item before an answer is provided.

In some embodiments, a question about the key and/or time signature of the piece should elicit attention to regions 362 and/or 364, respectively. A question which relates to the pitch of a note 370, 372 should be answered after the exam subject demonstrates attention to the key signature 362 and note 370, 372, potentially shifting attention between them. If the question relates to the notes themselves (for example “what is the interval between the indicated notes”, then a rule for the exam item potentially relates to a pattern of at least one saccade between them, indicating engagement with the test item.

A question requiring a higher-level analysis, such as “where is the end of the first musical phrase?” is expected to elicit quite complicated attentional behavior, ranging through region 366. In particular, attention is likely to focus for a period within region 367, potentially indicating that the subject is closing in on a correct answer. Similarly, a question which asks an exam subject to identify the largest climax in the passage shown should lead to general scanning of the exam elements, eventually settling for a period of increased focus on element 368.

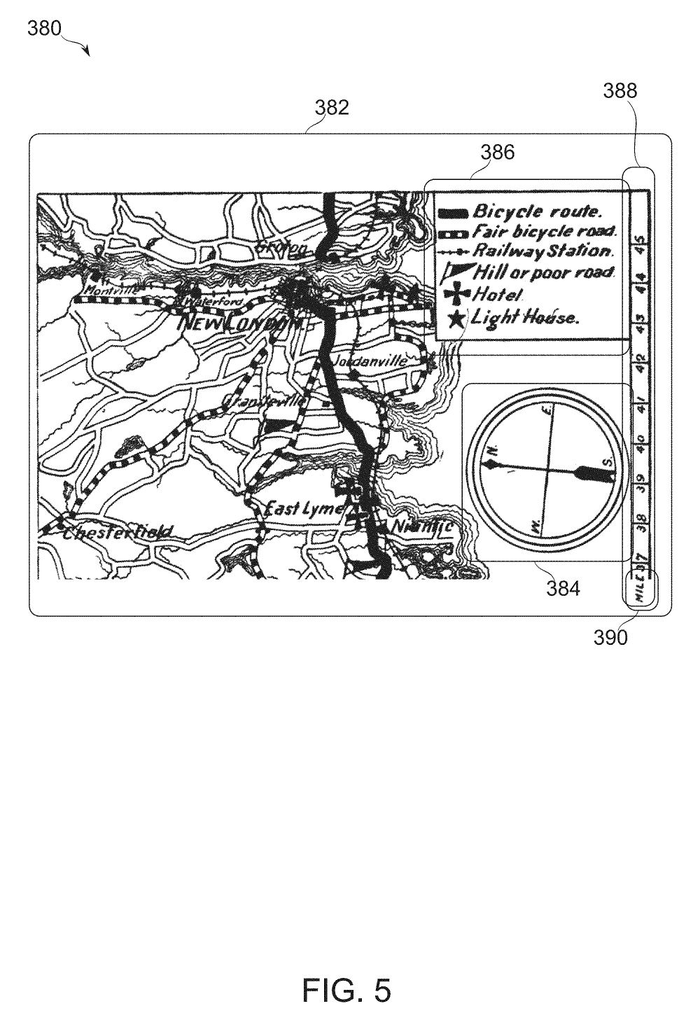

Reference is now made to FIG. 5, which is a region-labeled representation 380 of symbolic, non-textual elements (a map 382 including annotations) comprised in an exam item, according to some exemplary embodiments of the invention.

In some embodiments of the invention, an exam item relates to interpretation of a graph, image, or other complex visual representation, such as a map. FIG. 5 comprises an 1895 bicycle road map 382 from a region of Connecticut. It includes regions having common elements of a map, including a compass rose 384, a map scale 388 having a marker 390 indicating that the scale is in miles, and a map key 386. Many questions potentially asked by an exam item would require a test subject to consult one or more of these regions before answering the question. Correctly answering a question about distances, for example, would entail consulting scale 388, and more particularly, the unit marker 390. A question about a route phrased in terms of compass directions is expected to result in at least one, and potentially several attentional references to the compass rose 384. A question about the quality of a certain route, so specified, would require reference to the compass rose 384, and the map key 386; and more specifically, to the top portion of the map key 386. As in other types of questions, key regions and/or expected attentional relationships among key regions, are identifiable based on the content of the exam question, and/or based on inspection of attentional patterns recorded by previous exam subjects.

### Pattern Checks and Actions

Reference is now made to FIG. 6, which is a schematic flowchart representing activities related to attention monitoring while an exam subject answers an exam item, according to some exemplary embodiments of the invention.

In some embodiments, a check of currently observed attention (attentional behavior) against one or more attentional templates is performed at the exam item level. In some embodiments, checking is performed during an exam. Optionally, feedback on pattern check results is provided during the exam, including undertaking one or more actions.

At block 602, in some embodiments, an exam item is presented. Exemplary exam items are described, for example, in relation to FIGS. 3A-5. The presentation of exam items is described, for example, in relation to FIGS. 1-2B.

At block 604, in some embodiments, one or more monitoring means are used to monitor the behavior and/or attention of an exam subject. Monitoring means and monitored behaviors (and/or other attention-related phenomena) are described, for example, in the overview, and/or in relation to FIGS. 1-2B hereinabove.

At block 606, in some embodiments, an exam response is received, ostensibly from a designated exam subject. In some embodiments, the response comprises a computer-recognized response, such as a selection from a multiple choice response list.

In some embodiments, the response is another computer-recognized response, for example, a numerical answer, or a short text response. In some embodiments, the answer is essentially meaningless to the test providing system, except insofar as providing it represents a checkpoint in the time course of the exam item. In some embodiments, the answer is ignored.

At block 608, in some embodiments, item-level pattern checks are performed. Item level pattern checks compare observed attention (attentional behavior) to one or more pattern templates. Where observed attention is found to relate to a template (for example, to match it, to match it within some tolerance, and/or to match it within some degree of probability), an action is optionally triggered. The meaning of a template match is to be understood, for example, in light of the examples of FIGS. 3A-5 and their discussions, and in light of exemplary quantification details for event descriptions given in relation to other figures hereinbelow. In some embodiments, a pattern check is also referenced to the answer provided by an examinee. For example, a correct answer with a potential “cheater's profile” is used to signal a possible exam irregularity in progress. Additionally or alternatively, a wrong answer provided when a number of attention patterns appear to indicate an expected correct answer potentially serve to raise an indication to an instructor to assist the examinee; for example, to offer the examinee general encouragement to re-verify their answers.

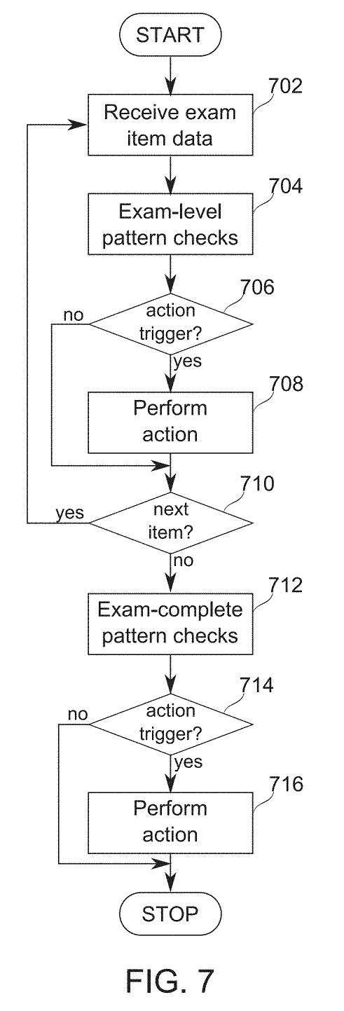

An item-level pattern check relates primarily to attention measured within the scope of a single exam item. It is to be understood that some important attention identifications—particularly identification of cheating—become clear with respect to an overall pattern of exam-taking behaviors, for example as described in relation to FIG. 7. Nevertheless, an item-level pattern check is potentially influenced by previous behavior of a particular subject. For example, a time window is potentially adjusted to take into account a faster or slower exam item answering style. In another example, a pattern and/or the action taken upon a match thereto is adjusted depending on previous pattern matches; for example, to avoid repetitive messages, and/or bring into play checks which are more appropriate for a previously observed test-taking style.

It is to be understood that FIG. 6 presents a particular order of blocks for the purposes of providing an exemplar, and that this order is not limiting, nor are all blocks necessarily carried out. For example, in some embodiments, pattern checks are run before, after, and/or during receipt of an exam response. Similarly, actions optionally take place before a response is provided; pattern checks optionally are performed concurrently with actions performed as a result of a previous check, and so on.

At block 610, in some embodiments, a determination is made as to whether the conditions for an action trigger are met by one of the previous item-level pattern checks. If yes, one or more actions are performed at block 612. Otherwise, the flowchart ends.

At block 612, in some embodiments, an action is performed as a result of a matching pattern check. The scope of actions which are triggered comprises a range of possibilities, according to the embodiment and/or the goals of the test monitoring procedure.

In some embodiments, test monitoring is performed in order to identify cheating. An item-level pattern check is potentially not a reliable indicator of cheating as such. For example, a multiple choice test allows a correct answer to be a pure guess, which is not considered cheating, but is nevertheless is a reasonably likely event, consistent with any pattern of attentional behavior. Nevertheless, there are, in some embodiments, action triggers which relate to the goal of cheater identification. In some embodiments, a failure to engage in clearly identifiable legitimate attentional behavior patterns is noted (by match failure) for the current exam item. Additionally or alternatively, an attention pattern matches a predetermined “cheaters' profile”. It is a potential advantage, provided by some embodiments, for a triggered action to comprise a warning. The warning is, for example, a message to the exam subject, encouraging behavior which more clearly demonstrates engagement with the material.

For example, a skilled and legitimate test taker might read a question quickly and with immediate understanding, reducing the opportunity to find matches with patterns deemed critical. This is a pattern which an aware cheater could potentially mimic, and insofar as this is true, it is preferable not to exclude. A legitimate test subject could potentially be encouraged (subtly or directly) to look more closely at exam item during testing. This potentially reduces an incidence of false positive determinations that a subject may be cheating. Potentially, it reduces an incidence of true positives, insofar as a subject disposed to cheat is reminded (subtly or directly) of being monitored.

In some embodiments of the invention, an exam element is presented such that only the exam subject is likely to be able to read it correctly. For example, the text of one or more exam elements is presented at the place where the subject is currently looking. Optionally, an exam element is presented sequentially, for example, word-by-word, at whatever place the exam subject happens to be looking, and/or within a region to which the exam subject is instructed to attend. To make more difficult a prearrangement between a subject and a possible assistant, for example, a subject is optionally instructed to keep their gaze within one of a group of indicated regions of the screen. Optionally, the region indications move. Optionally, other parts of the screen are changed at the same time as an exam element is presented, potentially interfering with an onlooker's attempts to understand what is presented. Optionally, an entire exam item and/or exam is presented this way. Optionally, only a part of an exam item and/or exam element is presented this way.

In some embodiments, a “cheater's assistant” version of an exam item is provided, such that an onlooker is made more likely to read the exam item incorrectly, and/or with less certainty. For example, one or more provided answers are optionally provided with a switching region, which alternately reads (in an exemplary case) “is” or “is not”. When the exam subject focuses gaze on the switching region, the correct word(s) are shown. Optionally, the switch region changes to a misleading indication (and/or to a misleading indication with a higher probability) when not being gazed at. It is to be understood that various schemes of the timing of switching are implementable to further confuse a would-be assistant, such as making all regions switch and/or “freeze” together as the gaze of the legitimate exam subject moves over the exam item, making communication by gaze and/or by prearrangement more difficult. Furthermore, a stereotyped prearrangement for dealing with such switches between an exam subject and a confederate is optionally itself allowed for (and thus made detectable as a cheating pattern) in the design of the patterns considered relevant to the exam item. A potential advantage of a “switch region”-style of test item presentation (compared, for example, to one where an exam element is presented following the gaze of the exam subject) is that it allows the exam item to be read almost normally, while still obscuring critical information from an onlooker not synchronized with the test delivery system. Another potential advantage of including switch regions in an exam item is the simplification of the general problem of understanding (or otherwise capturing, encoding, and/or categorizing) the attention pattern of the subject to the exam item overall, to one of specifically relating to patterns of attending to the switch regions in particular.

In some embodiments, an exam subject (optionally, a subject suspected of cheating) is presented with a confirming question after a response. Optionally, a confirming question comprises elements of the previous item, rearranged, mixed with distracter elements, or otherwise altered so that someone who had attended to the exam item subject matter would have no difficulty responding correctly, but someone who had only engaged at the level of picking an answer according to its label would be likely to fail. For example, one or more offered answers to a multiple choice question, in some embodiments, are presented arranged with different choice labels, and the exam subject asked to choose the correct answer again, and/or confirm that the offered answer was or was not the chosen answer.

In some embodiments of the invention, an action comprises an alert sent to a test proctor. In some embodiments, for example, an automatic test bank comprises video feeds which a test proctor is able to access and review. Optionally, review is on-line, during test-taking. If an exam subject causes a potential cheating warning to be raised, a proctor can be notified to immediately review the record, and/or keep a closer eye on future exam items. Potentially, a human exam proctor will be able to discount (or confirm) an automated warning to avoid escalation of the situation further.

In some embodiments of the invention, test monitoring is performed in order to evaluate and/or improve test-taking skill as such. In some embodiments, an exam subject is provided with guidance during an exam, and/or during consideration of a single exam item, based on their attentional behavior. In some embodiments, this is not only done in relation to assessment/improvement of test-taking skill. For example, hints about exam-taking technique are provided to an exam subject in order to reduce the extent to which the subject is being “tested about how to take a test”, potentially allowing mastery of the subject matter of the exam as such to be more clearly demonstrated.

In some embodiments of the invention, deviation of the pattern of exam subject attention from one or more preferred attention templates, and/or matching of a non-preferred template, triggers an action comprising a reminder, and/or a direct or indirect indicator. For example, a subject is reminded to read all parts of the exam item before providing an answer, reminded to seek out key words, or otherwise prompted based on their behavior. Optionally, one or more relevant text elements which were not examined are pointed out, for example, by highlighting or another on-screen indication. In some embodiments, the instructions to the question comprise a list of recommended test technique attentional patterns, and/or a list of messages derived from a principle related to such a pattern. Optionally, as the patterns are fulfilled, an indication is made to that effect—for example, the instruction is removed, dimmed, or otherwise marked.

In some embodiments of the invention, an alert is sent to a test proctor and/or instructor upon a pattern match and/or failure to match. This provides a potential advantage in allowing the time of the proctor/instructor to be focused on exam subjects (examinees) who are struggling with a test item. In some embodiments, the proctor/instructor intercedes with the test subject and makes a comment and/or correction.

Reference is now made to FIG. 7, which is a schematic flowchart representing activities related to attention monitoring integrating data from several exam items, and/or a whole exam, according to some exemplary embodiments of the invention.

In some embodiments, an exam comprises multiple exam items. In some embodiments, behavioral patterns are evaluated across groups of exam items—for example, items so-far complete, items linked by type, or another group. In some embodiments, behavioral patterns are evaluated over the whole test. Group-evaluation of exam items is used, for example to obtain a “non-cheating” verification, and/or to identify overall exam technique trends in an exam subject's attention patterns. In some embodiments, group-level analysis of attention patterns is performed before completion of a test, for example, to allow updating of pattern matching rules in response to a particular examinee's exam-taking technique.

At block 702, in some embodiments, the flowchart starts, and exam data is received. The exam can be either ongoing or completed. Exam data comprises, for example, attentional data, provided answers, and/or other information related to the examination session.

At block 704, in some embodiments, exam-level pattern checks are performed. The pattern check can be any of the patterns referenced in relation, for example, to FIG. 6. Additionally or alternatively, patterns comprise “patterns of patterns.” For example, one right answer without a supporting attention pattern is potentially a coincidence. However, a string of correct answers—where there is no reason based on attention monitoring to expect anything better than a guess—is a potential indication of cheating. Optionally, another index relating attentional behavior to exam results is used. For example, a measure of exam element coverage (by attention) is compared to performance on several or all exam items. A cheating subject potentially shows a different relationship between the coverage of exam elements attended to and scoring than is expected from a member of the non-cheating population.

Another such metapattern, in some embodiments, is a typical rate of exam item speed, or another examinee-specific parameter established by the examinee's own testing style. In some embodiments of the invention, patterns for matching comprise initial assumptions about parameters such as typical dwell and/or saccade times. Potentially, these assumptions are reasonable only for a subset of exam subjects. In some embodiments, initial attention profiles from an examinee are used to adjust the evaluation settings of the system, potentially improving the accuracy and/or value of results obtained.

In some embodiments, pacing and/or other monitored parameters potentially change normally over time, for example slowing as an exam subject experiences fatigue, or speeding as a subject gains familiarity with the test conditions. Parameters which change over time include, for example, a rate of saccade occurrence, a magnitude of saccade velocity, a rate at which exam answers are supplied, a frequency of returning to exam elements of a certain type (for example, difficult and/or key words and/or phrases), a latency between a presentation and a response, or another indicator of a change in the condition of the test subject. Optionally, test monitoring and attentional behavior-evaluating parameters adjust according to changes in monitored fatigue parameters.

In some embodiments, changing parameters are compared to expectation (generated based on a database of several subjects, and/or based on the recent and/or overall behavior of the current subject). Optionally, excursion from this expectation (for example, excursion sufficiently far away from a statistical expectation) is treated as an indicator of an overall pattern of behavior. Optionally, the overall pattern of behavior potentially indicates cheating, unusual stress, and/or another condition which potentially requires additional action from the side of a teacher and/or exam administrator.

In some embodiments, items are inserted into an exam specifically for use in exam-level evaluations. For example, an easy item is inserted to establish typical dwell and/or saccade times for a non-challenging task, with respect to which performance on other exam items is evaluated.

In some embodiments, mixing items of varying difficulty, depth, and/or relevance into an exam item set complicates the task of a would-be cheater. An easy exam item, for example, can be inserted to elicit a change in the pacing and/or patterning of response, which would require a cheater to notice and shift their style of response to, or else raise a suspicion. Optionally, such changes are induced by another method, such as a particularly hard or deep question, or an irrelevant or strangely assembled exam item. For example, a multiple choice item potentially presents all identical answers, or presents a complex-appearing question followed by the clear instruction to ignore the test item and move to the next one. An exam subject who appears not to react to such insertions is optionally considered, with higher probability, to be engaged in cheating. Another approach is to prompt a potential cheater with a question about a detail of a previously shown item to which they almost certainly did not attend, based on behavior monitoring. Answering such a question correctly (and/or doing so consistently) optionally raises a suspicion of cheating.

It is to be understood that blocks of this drawing are presented separately and in a particular order for purposes of description. In some embodiments, actual occurrence of activities associated with different blocks is in a different order, simultaneous, and/or interleaved, insofar as this is consistent with the nature of the activities themselves.

At block 706, in some embodiments, results of checks are examined to determine if an action should be triggered. If not, the flowchart continues at block 710.

Otherwise, at block 708, in some embodiments, a triggered action is performed. In some embodiments, the action comprises recording a status. In some embodiments, the action comprises a change in parameters used in the monitoring system, for example, to configure the system for the examination style of a slower or faster examinee than the system was previously configured for. In some embodiments, the action comprises a notification to the examinee and/or to exam administration personnel.

Branching from block 710, in some embodiments, the flowchart returns to receive more exam data at block 702 (if the exam is continuing). Otherwise, the flowchart continues at block 712.

At block 712, in some embodiments, final exam checks are performed. For example, a final evaluation is made as to whether test item attention is sufficiently well correlated with answers provided that the test result should be considered to be verified. If verification is not possible, in some embodiments, a recommendation is made to re-test the subject under direct supervision. Other final evaluations, in some embodiments, comprise an overall evaluation of an examinee's test-taking style. In some embodiments, potential weaknesses in examination-taking technique are scanned for, for example, based on frequency and/or severity over the course of the entire examination. Again, “metapatterns”, which can comprise combinations of attention patterns noted at the whole test, partial test, and/or exam item level, are used in some embodiments to produce an overall evaluation of the examinee's test-taking attention patterns.

At block 714, in some embodiments, pattern check results are evaluated for indicating an action trigger. If not, the flowchart stops.

Otherwise, at block 716, in some embodiments, an action is performed. For example, a recommendation to retest under supervision is issued, a report is provided which indicates one or more exam technique weaknesses, or another action is performed.

Rule, Event Description, and/or Ground-Truth Determination

Automatic Determination of Pattern Behavior

Reference is now made to FIG. 8, which is a schematic flowchart representing automatic determination of a pattern template for use in monitoring examination performance, according to some exemplary embodiments of the invention.

In some embodiments of the invention, a template pattern for an exam item is determined based on a database of attentional behavior obtained from already recorded examinees. A potential advantage of this is to reduce the labor involved in marking up an exam item for use in attention-guided monitoring of examinee engagement and/or exam technique training. The method of automatic template generation is potentially most useful for high-value exam item which is to be deployed to numerous exam sessions after a period of exam development. However, in some embodiments, an attention pattern template is developed based on a relatively small number of test sessions, optionally as few as one.

At block 802, in some embodiments, exam attention data related to an exam is obtained.

In some embodiments, exam attention data comprises collected data from actual or mock exam trials in which examinees interacted with an exam item substantially under the circumstances expected for the future. The number of test recordings used is, for example, 1-10, 5-20, 15-40, 20-50, 80-100, 50-200, 100-1000, or another range having the same, smaller, larger and/or intermediate bounds. In some embodiments, whole or partial manual or automatic categorization of patterns is performed; for example, patterns are identified as indicative of cheating, of good performance, and/or of poor performance. In some embodiments, patterns are further categorized according to modes; for example, according to different identifiable strategies correlated with cheating and/or quality of performance.

In some embodiments, a skilled test developer performs mock interaction with the test item in order to generate one or more data sets as a basis for extracting a typical pattern. In some embodiments, the test developer, optionally already familiar with the test, runs through the attentional patterns of one or more model examinees, based on familiarity with actual results from similar types of questions. Optionally, the recorded pattern becomes part of the source dataset. In some embodiments, one or more deliberate cheating patterns are recorded. Optionally these patterns include one or more cheating patterns which attempt to “game” features of the attention pattern recognition system itself, in order to provide input for increasing system sensitivity and/or robustness. In some embodiments, recorded patterns are cleaned of potential distracter data (for example, by manual recognition and removal) before use as a template.

At block 804, in some embodiments, attention data is analyzed for patterns. In some embodiments of the invention, analysis comprises identification of salient features of the attention pattern. Salient features include, for example, regions that are repeated targets of fixation, targets of notably long or short fixations, targets of long saccades (jumps in attention from a distant point), chains of short saccades in a stereotyped pattern, repeated jumping off points for saccades (long or short), and/or another pattern of space, time, and/or region relatedness. In some embodiments, the occurrence of a salient feature comprises itself a notable pattern. In some embodiments, chains of salient features repeat, and are considered a notable pattern on that ground.

The threshold for “notable”, in some embodiments, comprises a relative frequency of occurrence over some baseline expectation, for example random fixation to any point, or random fixation to any word or symbol. The threshold may be, for example, 1, 2 or 3 standard deviations away from random expectation (or a larger, smaller, or intermediate standard deviation), or another statistical measure. In some embodiments another baseline is used to select particular salient points and/or their combinations as notable. In some embodiments, patterns which differ in occurrence and/or frequency between two or more relevant examinee types are selected as notable. For example, patterns mainly preceding a successful answer form a first group of notable patterns, and patterns mainly preceding a wrong answer form a second group of notable patterns. In some embodiments, sub-groups corresponding to different exam strategies and/or error types are identified, for example by an analysis for separating statistical components of a population (principal component analysis, for example).

In some embodiments of the invention, notable patterns are assigned a weight according to their frequency of correlation with a correct, incorrect, and/or “cheated” test outcome. A pattern is optionally assigned a high verification weight when present, and/or a low or zero “anti-verification” weight for its absence. In another example a notable pattern is common for any correct response, but also occurs when a wrong response is given. The pattern is assigned a low or moderate verification weight when it is present, but a high weight, when absent, as an indication of negative verification of the subject's correct understanding of the exam item.

In some embodiments of the invention, an overall pattern of behavior is determined based on weightings of individually defined patterns. For example, a cheating likelihood is determined based on the appropriately weighted overall frequency of cheating-like behaviors measured. In some embodiments, fit optimization techniques are used to find matches to individual behavior patterns and/or to overall behavior patterns. Optionally, fit optimization is by use of a machine learning technique. For example, a classifier such as a neural network or a decision tree is implemented in some embodiments.

At block 806, in some embodiments, identified patterns are provided as templates. Optionally, the templates are provided with weightings which help to set their relative importance.

In some embodiments, these templates serve as the direct input to an attentional monitoring and evaluation system. In some embodiments, they are proved as input which substantially comprises an event description. Linkage of the description to an outcome (for example a triggered action) is, in some embodiments, according to a provided category for the pattern source. If a pattern is primarily noted in a cheater's input, for example, the action provided for the event description is optionally linked to one or more actions for handling this situation during an actual test. In some embodiments, further markup is added, for example, by another automatic evaluation method, or by a manual evaluation method, for example as described hereinbelow in relation to FIG. 9.

### Manual Event Description

Reference is now made to FIG. 9, which is a schematic flowchart representing manual and/or combined manual and automatic determination of a pattern template for use in monitoring examination performance, according to some exemplary embodiments of the invention.

In some embodiments, event descriptions are provided based on manual input, according to a user's understanding of the attentional relevance of one or more exam item elements. The choice of attention patterns in this case is determined primarily by the use of judgment to determine (for example as described hereinabove in relation to FIGS. 3A-5) which patterns are most likely to occur for different types of examinee. In some embodiments, automatic event descriptions are provided as a basis for manual refinement. In some embodiments, raw attentional data based on recorded interactions with an exam item is provided to guide the choices of a template builder.

Manual building of event descriptions has the potential advantage of allowing human insight and understanding to predict what patterns (or failing “anti-patterns”) of attention should be expected during an examination. Potentially, this increases the likelihood of choosing patterns that will be resistant to a knowledgeable cheater attempting to bypass attention checks by engaging in an easily demonstrated pattern of “fake attention”. Additionally or alternatively, manually built event descriptions are defined which mimic anticipated cheating behaviors.

The flowchart of FIG. 9 is consistent with a “what you see is what you get” (WYSIWYG) computer interface-driven method of building a set of event descriptions (pattern templates with associated actions) for an exam item. It is to be understood, however, that other implementations are possible which arrive at an equivalent result. In some embodiments, direct coding of a descriptive document is performed (for example, in a dialect of XML, JSON, or another appropriate markup). In some embodiments, a WYSIWYG input implementation is provided which comprises more or fewer features that those described herein.

At block 902, in some embodiments, an exam item is presented to a test builder. Optionally, the exam item is presented substantially as it would appear to an examinee during a test. In some embodiments, the test builder is provided with a version of the exam item which is susceptible to markup annotation of its elements, the markup being provided either with the exam item itself, or as a separate input.

At block 904, in some embodiments, a test builder flags key regions of the exam item. In this instance, a key region is any region which is to be identified, whether or not it is “key” to an understanding of the exam item itself. The flagging comprises, in some embodiments, direct marking of a region (for example dragging a rectangle, circle, or other shape around the region). In some embodiments, another marking method is used, for example, tagging a representation of the text which will comprise the region using a markup tag.

At block 906, in some embodiments, a test builder indicates relationships among key regions, and or key regions standing alone, as comprising the pattern templates of one or more corresponding event descriptions. The structure of an event description optionally comprises one or more of any convenient number of parameters and qualifiers. The event “occurs” when all of its conditions are met. In some embodiments, an event occurs by one or more a plurality of defined routes. For example, in addition to defining a number of triggering conditions, an event description defines conditions in one or more particular orders, and/or with some triggering conditions defined as equivalent alternatives to one another. Although described in relation to manual event definition, it should be understood that an automatic event definition means, in some embodiments, uses some or all of the same parameter types and/or ranges.

For example, a number of regions comprised in an event description is 1, 2, 3, 4, or any higher number. Additional parameters determine what happens in these regions to potentially trigger the event. In some embodiments, the event comprises no particular region, for example, a case where an answer is provided too quickly for understanding of the question at all. Regions are optionally marked as required or optional for the event. Optionally, a minimum number of regions (of those listed) is defined for the event.

In some embodiments, parameters which describe what happens to trigger an event comprise entry (of attention, and/or more particularly a visual saccade) into a region, exit from a region, movement within a region, and/or movement between a plurality of regions (for example, 2, 3, 4 or more regions).

In some embodiments, a time between entry and exit within a region (a “dwell time”) is specified as lower than a value, within a range, and/or greater than a value. For example, the event triggering dwell time is 0-100 msec, 50-200 msec, 0-500 msec, 100-500 msec, 400-1000 msec, 2000-5000 msec or more, or another range of dwell times having the same, larger, and/or intermediate bounds. In some embodiments, a time between exiting one region and entering another (“transfer time”) is specified, for example, as being within a period of 0-20 msec, 10-50 msec, 40-100 msec, 60-200 msec, or another range of transfer times having the same, larger, and/or intermediate bounds.

In some embodiments, a count of an exit, entry, or both to a region (an “access count”) is specified for a region. An access count is for example, 0 counts, 1 count, ≧1 counts, ≧2 counts, 1-5 counts, 6-10 counts, or another range of access counts having the same and/or intermediate bounds. In some embodiments, a number of distinct saccades (“dwell activity”) within a region is specified, example, 0 counts, 1 count, ≧1 count, ≧2 counts, 1-5 counts, 6-10 counts, or another range of dwell activity saccade counts having the same, larger or intermediate bounds. It is to be understood that a “distinct saccade” is itself definable in terms of parameters such as speed, dwell time, distance, and/or direction.

In some embodiments, triggering another event description comprises part of the triggering conditions of an event description. For example, an event description which captures the attention pattern of an examinee performing self-verification (scanning among exam item responses) before giving a final answer becomes triggerable after (optionally only after) an event comprising motion of a mouse cursor to one of the available responses to the exam item. Optionally, an event description is triggered retroactively. For example, a provided answer after a possible self-verification pattern optionally triggers a re-evaluation of the immediately preceding period, potentially leading to a re-identification of the pattern and its meaning. It should be understood that at least a portion of the possibility for real-time feedback is lost for such a case.

The foregoing exemplary parameters for event definition should be understood as exemplary, and not exhaustive or limiting. They comprise an indication to one skilled in the art of how a computer-implemented set of rules for evaluating saccades results, in some embodiments, in an automatic association of attention, attentional behavior, and/or tracked eye movements with particular patterns of activity having statistical and/or recognized meaning.

At block 908, in some embodiments, actions are assigned to defined attention patterns. Exemplary relationships among attention patterns and resulting actions are discussed, for example, in relation to the exemplary exam items of FIGS. 3A-5 hereinabove, and the “crow/raven” question accompanying Table 1.

At block 910, in some embodiments, a determination is made as to whether there is another exam item to be scored. In some embodiments, an overall exam is scored in a single session. In some embodiments, exam items are developed independently, and assembled into an exam according to need. If there is another exam item to score (this is not the last item), the flow chart returns to block 902. Otherwise, the flowchart ends.

### Exam Item Quality Assurance

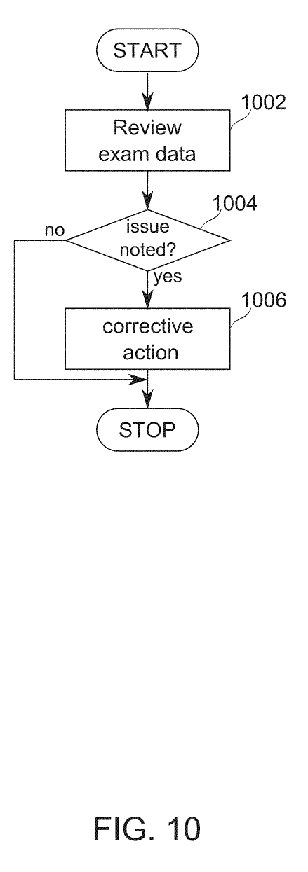

Reference is now made to FIG. 10, which is a schematic flowchart representing quality assurance testing for an examination, based on attention monitoring of a sample of examinees, according to some exemplary embodiments of the invention.

In some embodiments of the invention, a high-value exam item (for example, one which is expected to be used in many test sessions) is subjected to quality assurance testing, for example to identify potential problems with the wording and/or content of the item. In some cases, there is effort made, particularly for commonly administered psychometric tests (for example, university entrance exams) to ensure an appropriate balance of test questions, for fairness among exam subjects, and/or for fairness among tests administered at different times. It is a potential advantage to provide insight into what attentional processes lay behind the rate of correct response to a particular exam item. Potentially, knowing one or more of the reasons why an exam item is sometimes answered incorrectly (optionally with an indication of frequency) allows the item to be adjusted with higher accuracy to a desired target level of correct responses.

In some embodiments, a method is provided in which attention monitoring comprises part of the exam item verification and/or validation process. In some embodiments, attentional patterns established for a test item (for example, according to a procedure described in relation to FIGS. 8-9, hereinabove) are subjected to testing to verify that important and/or common behavioral patterns which occur during test taking are correctly matched.

In some embodiments, the teaching itself is subject to quality review, and/or a there is a value for a deeper understanding of typical mistakes which allows improving teaching quality. For example, a common error made by several students potentially reflects a point at which teaching should be improved. Potentially, the error, and/or the nature of the error is not evident in the actually provided answer, but is evident in a pattern of delayed and/or confused attention displayed during the time before answering.

For example, in the “crow/raven” question, repeated errors in response are trivially interpretable as a failure to understand the meaning of the term a priori. However, if these words receive no special emphasis of attention which indicates confusion on this point, there is potentially a deeper problem. For example, the words “by definition” might be the point of confusion—either studied too much, or ignored. Such students are potentially unaware that a “by definition” is a signifier of a tautological assertion, and that a tautology, because it is never not true, is true a priori. The burden of improved teaching is thus potentially shifted from grasp of a definition, to a particular problem with applying it.

At block 1002, in some embodiments, exam data comprising attention monitoring during interaction with an exam item is reviewed. Review can be for any number of potential issues and/or types of issues, for example, issues of the type described hereinabove. Issues visible in this case comprise, for example, over-attention to an exam item element which is not considered relevant, under-attention to a relevant item, and/or a common pattern of attention which makes it clear that some examinees are putting a construction on the meaning of the exam item which was not intended (wrong key words focused on, and/or wrong relationships among them, for example). Evaluation can also be for the occurrence of behavior patterns which are not, or not correctly, categorized by an established set of event descriptors.

In some embodiments of the invention, attention monitoring data is partially or entirely synthesized by a scenario generator. For example, epochs of actually recorded attention data are strung together in different orders, as a way of evaluating the categorization performance of defined events in response to simulated situations. Additionally or alternatively, one or more epochs of simulated attention are created. The epoch can be entirely simulated (for example, as a series of saccades between words of an exam item element) or, for example, modified from an actually recorded epoch. Modification comprises, for example, speeding up, slowing down, and/or with introduction of randomization of time and/or attentional position.

At block 1004, in some embodiments, an issue is potentially noted. If none is noted, the flowchart ends.

Otherwise, at block 1006, in some embodiments, a corrective action is taken. For example, if attentional patterns suggest ambiguity of interpretation at a place where the exam question was meant to be clear, the exam question is changed. In the case of evaluation for purposes of improving teaching, a lesson plan is optionally changed. In a test-balancing scenario, in some embodiments, an adjustment is optionally made which reduces the likelihood of one or more wrong answers—or increases such a likelihood, according to the balancing requirement.

It is expected that during the life of a patent maturing from this application many relevant attention determining methods will be developed and the scope of the terms “attention” and “attentional behavior” is intended to include all such new technologies a priori.

As used herein, the term “about” refers to within ±10%.

The terms “comprises”, “comprising”, “includes”, “including”, “having” and their conjugates mean: “including but not limited to”.

The term “consisting of” means: “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

The words “example” and “exemplary” are used herein to mean “serving as an example, instance or illustration”. Any embodiment described as an “example or “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features except insofar as such features conflict.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

1. A method of detecting cheating in the provision of an answer to an exam item having a plurality of exam elements, the method comprising:
tracking locations within the exam item indicated by gaze directions of an exam subject toward a presentation of the exam item;
logging the tracked locations to form a set of measurements of attentional behavior;
classifying automatically the set of attentional behavior measurements using at least one location profile adapted to classify the set of attentional behavior measurements to a classification of cheating, according to the members of the plurality of exam item elements targeted by the attentional behavior; and
indicating potential cheating, based on the classifying.

2. The method of claim 1, wherein said indicating of potential cheating comprises an indicated level of confidence that cheating is occurring.

3. The method of claim 2, wherein said level of confidence is adjusted according to the result of one or more previous said classifyings.

4. The method of claim 1, wherein said provided answer is correct.

5. The method of claim 1, wherein the logging of tracked gaze direction-indicated locations within said exam item comprises automatic tracking of eye movement of the exam subject by a gaze tracking apparatus.

6. The method of claim 1, comprising tracking and logging exam item locations indicated by manipulation of an input device configured to indicate locations of said presentation.

7. The method of claim 1, wherein said logging comprises recording when said exam item locations are indicated.

8. The method of claim 1, wherein said at least one location profile comprises at least one event description, and said classifying comprises mapping said indicated exam item locations to said at least one event description.

9. The method of claim 8, wherein said at least one event description comprises a range of one or more of the following parameters to which the indicated exam item locations are mappable:
indicated location within the presentation of the exam item;
number of separate times said indicated location is logged;
duration of gaze fixation upon said indicated location;
interval of other logged location indications intervening between logging said indicated location and logging a second indicated location; and
interval of time between logging said indicated location and logging a second indicated location.

10. The method of claim 1, wherein said profile is determined by machine learning based on input comprising exam item location indications.

11. The method of claim 10, wherein said input exam item location indications are obtained from logging of behavior of one or more calibrating exam subjects.

12. The method of claim 10, wherein said input exam item location indications are at least partially artificially synthesized.

13. The method of claim 1, wherein said profile comprises at least one description of one or more indicated exam item locations, which at least one description, when said tracked and logged locations do not fit within a pattern described by said at least one description, is associated with an expectation of an incorrect answer.

14. The method of claim 1, wherein said profile comprises at least one description of one or more indicated exam item locations, which at least one description, when said tracked and logged locations fit within a pattern described by said at least one description, is associated with an expectation of an incorrect answer.

15. The method of claim 13, wherein fitting within a description comprises a degree of correspondence between said description and said tracked and logged locations sufficient to support the assertion of said association.

16. The method of claim 1, wherein an answer to an exam item comprises an exam item response recorded by the exam subject for use in exam evaluation.

17-44. (canceled)

45. A system for detection of potential cheating on an exam, comprising:
a gaze tracker, configured to:
track locations within the exam item indicated by gaze directions of an exam subject toward a presentation of the exam item, and
log the tracked locations to form a set of measurements of attentional behavior; and
a processor, configured to:
classify automatically the set of attentional behavior measurements using at least one location profile adapted to classify the set of attentional behavior measurements to a classification of cheating, according to the members of the plurality of exam item elements targeted by the attentional behavior; and
indicate potential cheating, based on the classification.
